(19) United States
(12) Patent Application Publication
(10) Pub. No.: US 2020/0069515 A1
(43) Pub. Date: Mar. 5, 2020

(54) HEALTH PROMOTING APPARATUS

(71) Applicants: NANOPLANET RESEARCH INSTITUTE LTD., Oita (JP); NANOPLANET CO., LTD., Oita (JP)

(72) Inventors: Hirofumi ONARI, Oita (JP); Kyoko ONARI, Oita (JP); Miaki ONARI, Oita (JP); Yoshito ONARI, Oita (JP); Moe ONARI, Oita (JP)

(73) Assignees: NANOPLANET RESEARCH INSTITUTE LTD., Oita (JP); NANOPLANET CO., LTD., Oita (JP)

(21) Appl. No.: 16/468,818

(22) PCT Filed: Dec. 15, 2017
(86) PCT No.: PCT/JP2017/045061

§ 371 Date: Jun. 12, 2019

(30) Foreign Application Priority Data
Dec. 16, 2016 (JP) 2016-244842

(51) Int. Cl. A61H 33/02; A61H 35/00

(52) U.S. Cl. CPC A61H 33/027; A61G 5/10; A61H 2203/0431; A61H 35/006

(57) ABSTRACT

It is an object to collect objective and quantitative experimental data, etc. and clarify, based on abundant examples that a microbubble generating device is useful for health promotion, and based on this clarification provide a health promoting apparatus. A mechanical bathing apparatus as a health promoting device includes a bathtub 10 as a water tank 1, forty microbubble generating devices 2 arranged on the bottom surface 11 of the bathtub 10, a pump P for sucking hot water or the like in the bathtub 10 via a water suction pipe 3 and circulating and supplying pressurized water to the MB devices 2 via a discharge pipe 4, and an air header 5 for supplying air to the each MB device 2.

### TECHNICAL FIELD

The present invention relates to a health promoting apparatus that applies a microbubble generating device to promotion of health, and particularly to a health promoting apparatus used in the field of care and welfare whose utility is expected.

### BACKGROUND ART

A foot bathing apparatus for relieving fatigue and promoting health by immersing feet in hot water or water has been conventionally known.

For example, the “foot bathing apparatus” of Patent Literature 1 has an object to “provide a foot bathing apparatus capable of obtaining a blood circulation promoting action, a sedative action, and an autonomic nervous control action which are superior to those of conventional foot bathing apparatuses” (paragraph [0006] in the foregoing Literature).

The above-described foot bathing apparatus 10 is configured to include a foot bathing container 11, plural microbubble generators 12 and 13 arranged in a casing 24a of a microbubble generating unit 24 immersed in hot water stored in the foot bathing container 11, a pump P for circulating and supplying the hot water in the foot bathing container 11 to the microbubble generators 12 and 13 through a water feeding pipe 18, and gas flow paths 14a, 14b and 15 for supplying air to the microbubble generators 12 and 13.

It is described as the effect of the above-described foot bathing apparatus 10 in paragraph [0016] of the above-described literature that “it is possible to obtain a blood circulation promoting action, a sedative action, an autonomic nervous control action”, and it is also described in paragraph [0040] of the same literature that “fluid mixed with microbubbles NB swirling in the microbubble generators 12 and 13 and ultrasonic waves considered to be caused by cavitation can be observed in the vicinity of a discharge port 28, and it is guessed that such ultrasonic waves enhances the blood circulation promoting action and may contribute to the sedative action and the autonomic nervous control action described above”.

However, the “blood circulation promoting action” and the like by the microbubble generators of the above-described literature 1 are limited to qualitative description (see paragraph [0052] of the above-described Literature 1, Table 1), and description on supportive objective quantitative experimental data, etc. is not necessarily provided.

### CITATION LIST

### Patent Literature

Patent Literature 1: Japanese Patent No. 4807968

### SUMMARY OF INVENTION

### Technical Problem

Therefore, the present invention has an object to clarify, based on abundant examples, that a microbubble generating device is useful for health promotion by arranging objective quantitative experimental data, etc., and provide a health promotion apparatus under the clarification, and particularly to provide a health promotion apparatus used in the field of care and welfare whose utility is expected, provide a health promotion apparatus that is applied not only to the feet of a user, but also to each site of the user's body with the microbubble generating device as a site to be applied to health promotion, provide a health promotion apparatus that reflects on-site voices involved in the field of care and welfare, develop “stationary type” into “movable type” although the mainstream of conventional foot bathing apparatuses, etc. has been “stationary type as in the case of Patent Literature 1, and enable the use of the health promotion apparatus to spread to pets as pet animals.

### Solution to Problem

In order to attain the above object, a health promoting apparatus according to the present invention is a health promoting apparatus for promoting health of a jetting target object that comprises; a microbubble generating device that includes a container main body having a cylindrical space having a gas introduction hole formed on one end side thereof and an opening portion formed on the other side thereof, and a pressurized liquid introduction port opened in a tangential direction thereof at a part of a peripheral surface of an inner wall of the cylindrical space and connected to a pipe for feeding pressurized liquid; and a water tank for accommodating a jetting target to be exposed to microbubbles jetted by the microbubble generating device and liquid containing the microbubbles, wherein a plurality of microbubble generating apparatuses connected to branch pipes branched from the pipe are arranged so as to be opposite to the jetting target, and the opening portions are arranged in the water tank so as to face the jetting target (an invention of claim 1).

In the health promoting apparatus, the microbubble generating device has a negative potential of about minus 40 millivolts in liquid, and generates lots of microbubbles each having a diameter of about 10 to 40 μm, most of the microbubbles contracting from just after the generation thereof (an invention of claim 2).

In the health promoting apparatus, a cap through which microbubbles jetted from the opening portion are jetted like a shower is freely detachably attached on the other side of the microbubble generating device (an invention of claim 3).

In the health promoting apparatus, the opening portion is arranged such that microbubbles can be proximately jetted to the jetting target (an invention of claim 4)

In the health promoting apparatus, the water tank is a bathtub, the jetting target object to be accommodated in the bathtub is a jetting target person who bathes while sitting on a seat portion of a chair or a jetting target person who bathes in a lying posture, and the microbubble generating devices are arranged on a bottom surface and a side wall surface of the bathtub (an invention according to claim 5, hereinafter also referred to as mechanical bathing apparatus).

In the health promoting apparatus, the jetting target to be accommodated in the water tank is legs of the jetting target person, and the opening portion is arranged so as to be opposite to legs and so as to face right and left insides of both the legs (an invention according to claim 6, hereinafter also referred to as foot bathing microbubble apparatus).

In the health promoting apparatus, a connecting portion for connecting to an adjacent water tank is provided at a front portion of the water tank, and connecting portions of adjacent water tanks are connected to each other by a handle to provide a foot bathing microbubble apparatus for at least two persons (an invention according to claim 7).

In the heath promoting apparatus, the jetting target to be accommodated in the water tank is feet of a jetting target person sitting on a wheelchair, and the water tank is configured to have a shape which enables insertion of the water tank into a space under a seat surface of the wheelchair, and the opening portions are arranged on a bottom surface of the water tank so as to face undersides of both the feet, and are arranged on a rear surface of the water tank so as to face Achilles tendons of both the feet (an invention according to claim 8, hereinafter also referred to as wheelchair adaptable foot bathing apparatus).

In the health promoting apparatus, the jetting target accommodated in the water tank is one knee of a jetting target person, and the opening portions are arranged on a bottom surface and a front surface of the water tank (an invention according to claim 9, hereinafter also referred to as one-knee bathing microbubble apparatus).

In the health promoting apparatus, the jetting target to be accommodated in the water tank is both knees of a jetting target person, and the opening portions are arranged on a rear surface of the water tank, enable proximate jetting of microbubbles via a flexible pipe, and are arranged so as to face front sides of both the knees (an invention according to claim 10, hereinafter also referred to as both-knees bathing microbubble apparatus).

The one-knee bathing microbubble apparatus further comprises a chair including a seat portion for supporting buttocks of a jetting target person, and a slope portion for supporting a chest of a jetting target person in a stooped state (an invention according to claim 11).

In the health promoting apparatus, the jetting target to be accommodated in the water tank is an upper limb of a jetting target person, and the opening portions are arranged on a bottom surface of the water tank (an invention according to claim 12, hereinafter also referred to as upper limb care bathing apparatus).

In the health promoting apparatus, the jetting target to be accommodated in the water tank is upper limbs of a plurality of jetting target persons, and the opening portions are arranged on a plurality of side surfaces of the water tank (an invention according to claim 13, hereinafter also referred to as upper limb care bathing apparatus).

In the health promoting apparatus, the jetting target to be accommodated in the water tank is a face of a jetting target person, the opening portions are arranged on a bottom surface and a side surface of the water tank, enable proximate jetting of microbubbles via a flexible pipe, and are arranged so as to face the face of the jetting target person (an invention according to claim 14, hereinafter also referred to as face washing apparatus).

In the health promoting apparatus, the jetting target to be accommodated in the water tank is a hand of a jetting target person, and the opening portions are arranged on a bottom surface of the water tank, enable proximate jetting of microbubbles via a flexible tube and are arranged so as to face the hand of the jetting target person (an invention according to claim 15, hereinafter also referred to a hand washing apparatus).

In the health promoting apparatus, the jetting target object is a pet as a pet animal, and the opening portions are arranged on a bottom surface or a side surface of the water tank (an invention according to claim 16, hereinafter also referred to as pet washing apparatus).

Any one from the foot bathing microbubble apparatus to the pet washing apparatus is provided with a movable carriage (an invention according to claim 17).

In any one from the foot bathing microbubble apparatus to the pet washing apparatus, a volume of the water tank of each of the microbubble generating devices is about 1 liter to about 20 liters (an invention according to claim 18).

In the health promoting apparatus, the water tank and a pump for feeding pressurized fluid to the microbubble generating devices arranged in the water tank are provided on separate movable carriages (an invention according to claim 19, hereinafter also referred to as delivery foot bashing apparatus).

Any one from the foot bathing microbubble apparatus to the pet washing apparatus is provided with a heater (an invention according to claim 20).

Any one from the foot bathing microbubble apparatus to the pet washing apparatus is provided with a timer for controlling an operation thereof (an invention according to claim 21).

Any one from the foot bathing microbubble apparatus to the pet washing apparatus can control a jetting pressure, a flow rate or a liquid temperature of liquid containing microbubbles (an invention according to claim 22).

### Advantageous Effects of Invention

In the health promoting apparatus according to the present invention, since the plurality of microbubble generating devices are arranged to be opposite to the jetting target, and the opening portions are arranged in the water tank so as to face the jetting target, the microbubble generating devices can be arranged to be integrated for the jetting target, the microbubbles can be filled at a high density in the water tank for the jetting target, and further intensive proximate jetting of microbubbles can be performed.

Therefore, the blood flow of the jetting target object is promoted, and also an effect of warm bathing and the like are exerted, so that the health promoting apparatus is useful for health promotion, and also can provide an effect such as cleaning of dirt adhering to the jetting target.

By arranging apparatuses from the foot bathing microbubble apparatus to the hand washing apparatus, it is possible to provide a health promoting apparatus that is applied to each site of the body.

Furthermore, the health promoting apparatus is configured so that plural persons can use the health promoting apparatus at the same time, whereby so-called “life living care bathing” can be planned, and on-site voices involved in the field of care and welfare can be reflected.

Since the movable carriage is attached to the foot bathing microbubble apparatus or the like, and further the water tank and the pump are respectively provided on different movable carriages, it is possible to perform departure from the “stationary type”.

Furthermore, use of the health promoting apparatus can be expanded to pets as pet animals.

### BRIEF DESCRIPTION OF DRAWINGS

FIG. 1 is a plan view showing a configuration of a mechanical bathing apparatus.

FIG. 2 is a cross-sectional view showing the configuration of the mechanical bathing apparatus.

FIG. 3A is a cross-sectional view of a microbubble generating device.

FIG. 3B is a cross-sectional view of a microbubble generating device of another example.

FIGS. 4(1) to 4(3) are a perspective view, an action explanatory diagram a front view of another container of another example configuring the microbubble generating device.

FIG. 5 is a plan view showing a foot bathing microbubble apparatus.

FIG. 6 is a longitudinally sectional view of the foot bathing microbubble apparatus.

FIG. 7 is a plan view of a wheelchair adaptable foot bathing apparatus.

FIG. 8 is a longitudinally sectional view of the wheelchair adaptable foot bathing apparatus.

FIG. 9 is a plan view of a one-knee bathing microbubble apparatus.

FIG. 10 is a longitudinally sectional view of the one-knee bathing microbubble apparatus.

FIG. 11 is a plan view of a both-knees bathing microbubble apparatus.

FIG. 12 is a longitudinally sectional view of the both-knees bathing microbubble apparatus.

FIG. 13 is a plan view of an upper limb care bathing apparatus.

FIG. 14 is a longitudinally sectional view of an essential part of the upper limb care bathing apparatus.

FIG. 15 is a plan view of an upper limb care bathing apparatus for four persons.

FIG. 16 is a longitudinally sectional view of an essential part of the upper limb care bathing apparatus.

FIG. 17 is a plan view of an upper limb care bathing apparatus of another example.

FIG. 18 is a longitudinally sectional view of the upper limb care bathing apparatus.

FIG. 19 is a plan view of a water tank of a delivery foot bathing apparatus.

FIG. 20 is a longitudinally sectional view of the water tank.

FIG. 21 is a plan view of a water tank of a delivery foot bathing apparatus according to another example.

FIG. 22 is a longitudinally sectional view of the water tank.

FIG. 23 is a drawing-substituting photograph of the microbubble generating device actually used in examples.

FIG. 24 is an explanatory diagram of an action of the microbubble.

FIG. 25 is a drawing-substitute photograph representing an action of the microbubble.

FIG. 26 is an explanatory diagram of an action of the microbubble.

FIG. 27 is an explanatory diagram of an action of the microbubble.

FIG. 28 is a drawing-substituting photograph representing an action of the microbubble.

FIG. 29 is a graph illustrating an action of microbubbles.

FIG. 30 is a graph representing an experimental result obtained by a mechanical bathing apparatus.

FIG. 31 is a graph representing an experimental result obtained by the mechanical bathing apparatus.

FIG. 32 is a drawing-substituting photograph showing an experimental result obtained by the mechanical bathing apparatus.

FIG. 33 is a drawing-substituting photograph showing a foot bathing microbubble apparatus for four persons which is actually used in examples.

FIG. 34 is a drawing-substituted photograph showing the foot bathing microbubble apparatus for four persons which is actually used in the examples.

FIG. 35 is a drawing-substituting photograph showing a foot bathing microbubble apparatus for two persons which is actually used in the examples.

FIG. 36 is a drawing-substituting photograph showing a foot bathing microbubble apparatus for one person which is actually used in the examples.

FIG. 37 is a drawing-substituting photograph showing a main part of a foot bathing microbubble apparatus which is actually used in the examples.

FIG. 38 is a graph showing an experimental result obtained by the foot bathing microbubble apparatus.

FIG. 39 is a drawing-substituting photograph showing an experimental result obtained by the foot bathing microbubble apparatus.

FIG. 40 is a drawing-substituting photograph showing an experimental result obtained by the foot bathing microbubble apparatus.

FIG. 41 is a graph showing an experimental result obtained by the foot bathing microbubble apparatus.

FIG. 42 is a graph showing an experimental result obtained by the foot bathing microbubble apparatus.

FIG. 43 is a graph showing an experimental result obtained by the foot bathing microbubble apparatus.

FIG. 44 is a drawing-substitute photograph of a wheelchair adaptable foot bathing apparatus which is actually used in the examples.

FIG. 45 is a drawing-substituting photograph of a state where the wheelchair adaptable foot bathing apparatus which is actually used in the examples is set in a wheelchair.

FIG. 46 is a graph showing an experimental result obtained by the wheelchair adaptable foot bathing apparatus.

FIG. 47 is a graph showing an experimental result obtained by the wheelchair adaptable foot bathing apparatus.

FIG. 48 is a graph showing an experimental result obtained by the wheelchair adaptable foot bathing apparatus.

FIG. 49 is a drawing-substituting photograph showing a configuration of a one-knee bathing microbubble apparatus which is actually used in the examples.

FIG. 50 is a graph showing an experimental result obtained by the one-knee bathing microbubble apparatus.

FIG. 51 is a graph showing an experimental result obtained by the one-knee bathing microbubble apparatus.

FIG. 52 is a graph showing an experimental result obtained by the one-knee bathing microbubble apparatus.

FIG. 53 is a graph showing an experimental result obtained by a both-knees bathing microbubble apparatus.

FIG. 54 is a drawing-substituting photograph of an upper limb care bathing apparatus which is actually used in the examples.

FIG. 55 is a drawing-substituting photograph of the upper limb care bathing apparatus which is actually used in the examples.

FIG. 56 is a drawing-substituting photograph of an upper limb care bathing apparatus of another example which is actually used in the examples.

FIG. 57 is a drawing-substituting photograph showing a usage state of the same upper limb care bathing apparatus actually used in the examples.

FIG. 58 is a drawing-substituting photograph of an upper limb care bathing apparatus for plural target persons to be jetted which is actually used in the examples.

FIG. 59 is a graph showing an experimental result obtained by the upper limb care bathing apparatus.

FIG. 60 is a graph showing an experiment result obtained by the upper limb care bathing apparatus.

FIG. 61 is a graph showing an experimental result obtained by the upper limb care bathing device for plural target persons to be jetted.

FIG. 62 is a graph showing an experiment result obtained by an upper limb care bathing apparatus for plural target persons to be jetted.

FIG. 63 is a drawing-substituting photograph of a delivery foot bathing apparatus which is actually used in the examples.

FIG. 64 is a drawing-substituting photograph of a water tank configuring a delivery foot bathing apparatus which is actually used in the examples.

FIG. 65 is a drawing-substituting photograph of a water tank configuring a delivery foot bathing apparatus of another example which is actually used in the examples.

FIG. 66 is a graph showing an experiment result obtained by the delivery foot bathing apparatus.

FIG. 67 is a graph showing an experimental result obtained by a delivery foot bathing apparatus of another example.

FIG. 68 is a graph showing an experimental result obtained by a delivery foot bathing apparatus of another example.

### DESCRIPTION OF EMBODIMENTS

### Mechanical Bathing Apparatus

A mechanical bathing apparatus according to an embodiment of the invention will be described with reference to drawings.

In this figure and respective subsequent figures described later, the same components are represented by the same reference signs, and duplicated description is omitted.

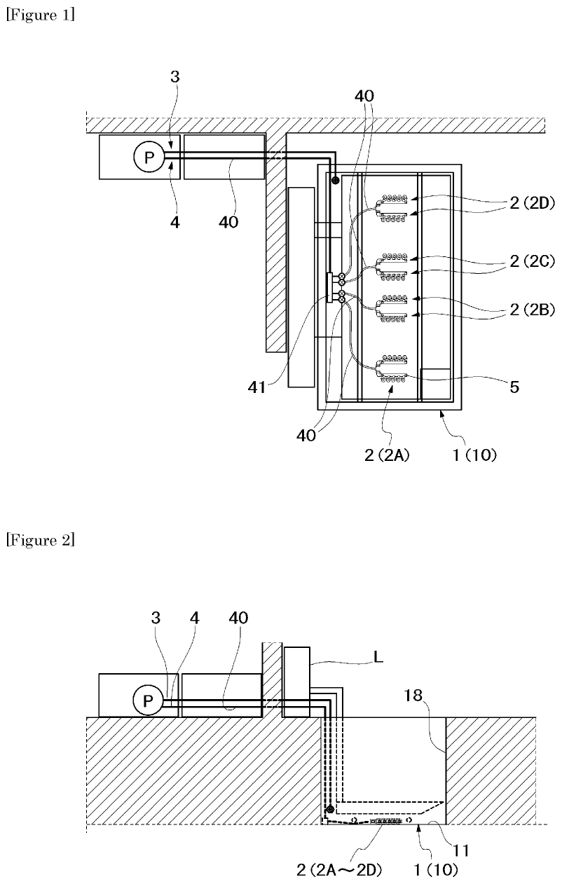

As shown in FIG. 1 and FIG. 2, the mechanical bathing apparatus includes a bathtub 10 as a water tank 1, plural microbubble generating devices (hereinafter also referred to as MB devices) 2 arranged on a bottom surface 11 of the bathtub 10, a pump P for absorbing hot water or the like in the bathtub 10 through a water suction pipe 3 and circulating and supplying pressurized water to the MB devices 2 through a discharge pipe 4, and air headers 5 for supplying air to the respective MB devices 2.

Although not shown, the MB devices 2 may be also arranged on a side wall 18 of the bathtub 10.

Note that a configuration for circulating and supplying the pressurized water to each MB device 2 by the pump P is substantially the same in the following embodiments and examples.

In this mechanical bathing apparatus, a jetting target T (not shown) taking microbubbles jetted by the microbubble generating devices 2 is a jetting target person who takes a bath while sitting on a seat portion of a chair such as a wheelchair or a jetting target person who takes a bath while lying down on a stretcher or the like, and the jetting target person is accommodated in the bathtub 10 via a lift L.

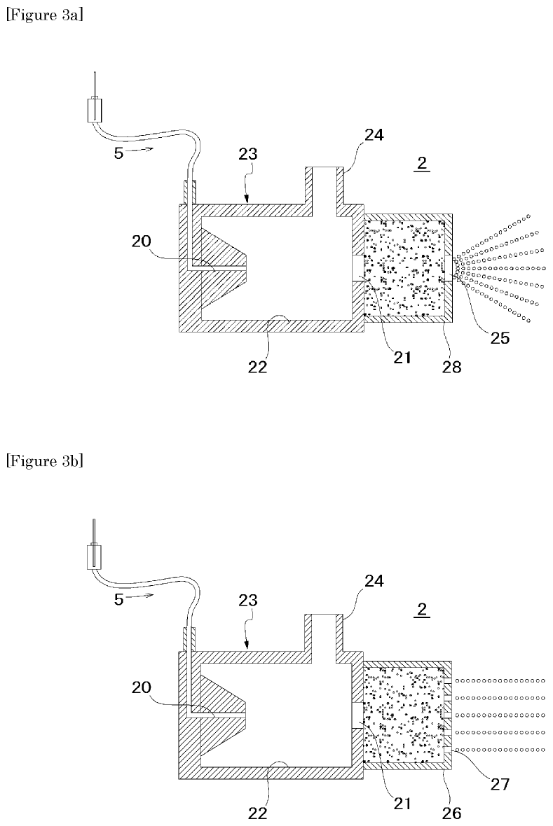

As shown in FIG. 3, the microbubble generating device 2 includes a container main body 23 having a gas introduction hole 20 which is formed to be opened in a wall body on one end side and connected to the air header 5, and a cylindrical space 22 having an opening portion 21 formed on the other end side, and a pressurized liquid introduction port 24 which is formed in a part of the inner peripheral surface of an inner wall of the cylindrical space 22 so as to be opened in a tangential direction of the inner peripheral surface, and connected to the discharge pipe 4 via a pipe 40.

As shown in FIG. 3A, a separate container 28 which includes a wall body having an opening 25 and can store liquid therein may be fitted to the other end side, the wall body being large enough to surround the opening portion 21. Furthermore, as shown in FIG. 3B, a separate container 26 having a large number of through holes 27 may be fitted to the other end side.

Furthermore, the separate container 26 or the separate container 28 may be used as a cap, and freely detachably fitted to the container main body 23 on the other end side by threading the container main body 23.

By providing these separate containers 26 and 28, high concentration gas solution (microbubbles) can be generated in the separate containers 26 and 28, so that microbubbles can be easily manufactured and supplied at any time.

By providing the separate container 26 or the separate container 28, microbubbles can be jetted like a shower.

As compared with jetting sounds from the opening portion 21, jetting sounds from the opening 25 of the separate container 26 or the through holes 27 of the separate container 28 can be mitigated.

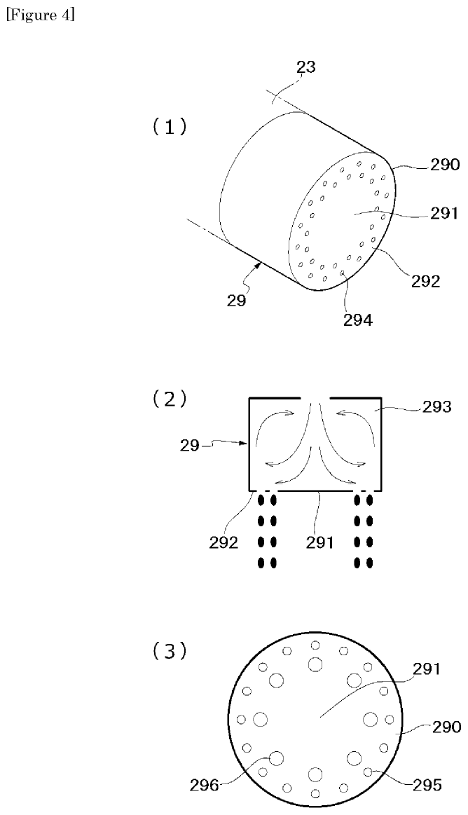

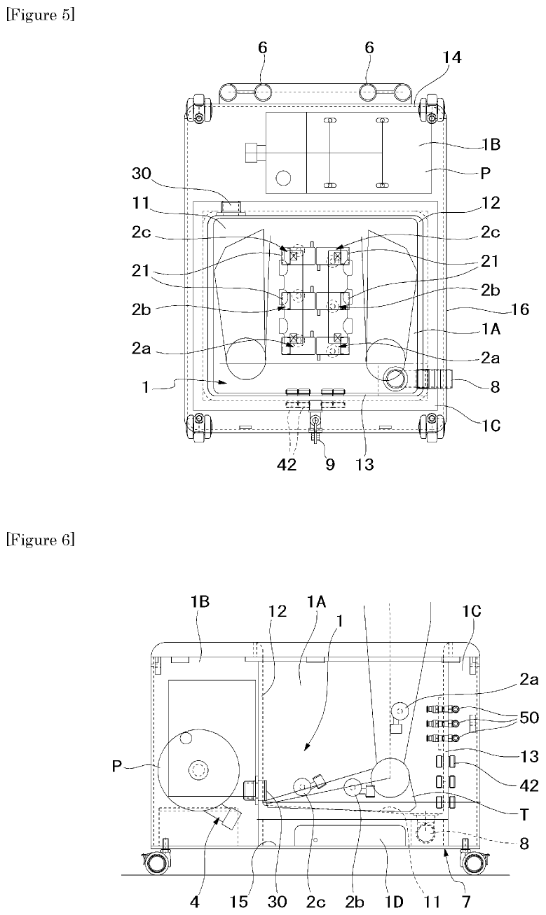

As shown in FIGS. 4 (1) and (2), on a cap front surface 290 of the separate container 29, a center portion 291 may be closed, and holes may be formed only on a peripheral portion 292 thereof.

Such a configuration makes it possible to form a circulating flow in a cap 293, increase the suction amount of gas from the gas introduction pipe 200, and enhance the pressure in the cap 293, whereby the shower-like liquid can be jetted at a higher speed.

As shown in FIG. 4 (3), with respect to the sizes of the holes to be formed, the diameter of outer holes 295 may be made smaller while the diameter of inner holes 296 is made larger, whereby two types of jetted liquid can be made to flow out.

For example, the diameter of the outer holes 295 is set to about 1 mm or so, and the diameter of the inner holes 296 is set to about 1.5 mm or so.

With respect to blowout from the outer holes 295, a cleansing function of skins and hairs is enhanced by further increasing the jetting speed of liquid from the holes 295, and further when the liquid contains a shampoo solution, finer bubbles are more multiplied by increasing the jetting speed, thereby enhancing the cleaning function.

With respect to blowout from the inner holes 296, a warm bathing effective function can be further enhanced by causing lots of microbubbles to be contained in the liquid to be jetted.

In the present specification, the “opening portion” contains not only the opening portion represented by the reference sign “21”, but also the opening represented by reference sign “25”, the through holes represented by reference sign “27” and reference sign “cap front surface 290”.

With respect to the microbubble generating devices 2, four sets of device groups (2A to 2D) are arranged on the bottom surface 11 of the bathtub 10 so as to face a jetting target person. Each of the device groups 2A to 2D is configured by, for example, ten MB devices 2, the air header 5 is connected to each of the device groups 2A to 2D, and each pressurized liquid introduction port 24 described above is connected to the discharge pipe 4, the pipe 40 and a branch pipe 42 (not shown) branched from the pipe 40 and passed through a branch portion 41.

The opening portions 21 of the respective microbubble generating devices 2 arranged as described above are positioned face up so as to face the entire body of the jetting target person.

Therefore, microbubbles jetted from the opening portions 21 ascend so as to enclose the jetting target person, and can promote the blood flow of the jetting target person.

### Foot Bathing Microbubble Apparatus

A foot bathing microbubble apparatus includes a water tank 1, and plural MB devices 2 which are arranged between both feet of the jetting target person accommodated in the water tank 1 as shown in FIGS. 5 and 6 so that the opening portions 21 are opposite to the feet and face the right and left insides of both the feet.

The water tank 1 includes a water tank main body 1A, a front chamber 1B, a rear chamber 1C and a bottom chamber 1D.

The water tank main body 1A has, on the bottom surface 11 thereof, a space in which the right and left feet of the jetting target T are placed and a space in which the plural MB devices 2 are arranged between both the feet, has a water intake 30 connected to the water suction pipe 3 (not shown) on a front surface 12 thereof, and has, on a rear surface 13 thereof, a branch port 42 connected to the discharge pipe 4 through the bottom chamber 1D and the rear chamber 1C and a socket 50 for an air pipe for supplying air to each MB device 2.

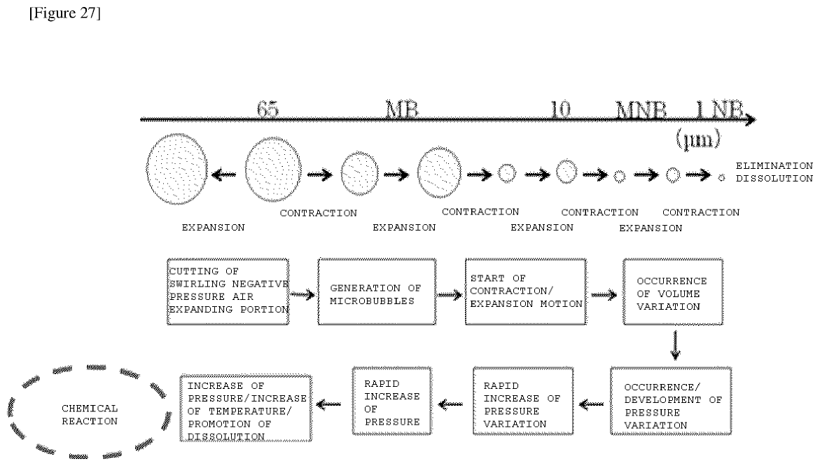

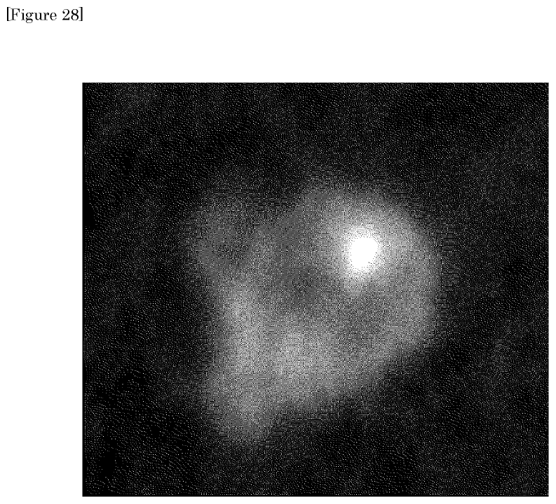

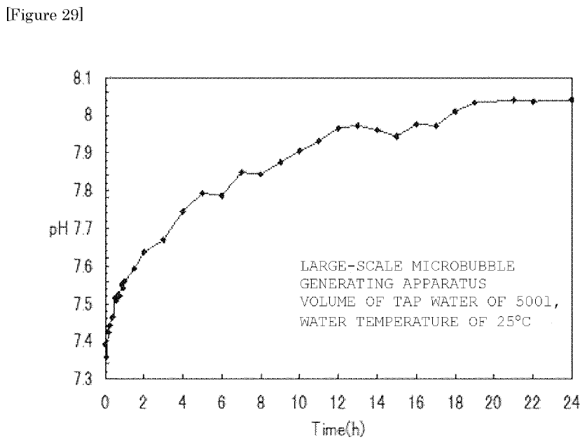

The branch port 42 is connected to the pressurized liquid introduction port 24 of each MB device 2 by the branch pipe 41 using, for example, a flexible tube (see FIG. 27). The socket 50 is connected to the gas introduction hole 20 of each MB device 2 via, for example, a tubular pipe.

The bottom surface 11 of the water tank main body 1A is gradually sloped downward from the fingertips of the feet to the heel as shown in FIG. 6 so that the feet is easily placed on the bottom surface 11, and a drainage port 8 is provided on the heel side to facilitate drainage.

Note that the pump P is arranged in the front chamber 1B.

With respect to the plural MB devices, for example, the opening portions 21 are arranged so that the opening portions 21 of the MB devices 2a face the ankles of the feet, the opening portions 21 of the MB devices 2b face the tops of the feet, and the opening portions 21 of the MB devices 2c face the toes of the feet, and jetting can be performed while the each opening portion 21 and the jetting target T is made close to each other at a distance of about 0.5 centimeters to about 10 centimeters.

The front portion 14 of the water tank 1 may be provided with connecting portions 6 each having a pair of cylindrical portions formed on right and left sides as shown in FIG. 5 (see also FIG. 33).

A handle 60 (see FIG. 33 and FIG. 34) is inserted into the cylindrical portions so as to make the handle 60 serve as a hand driving handle or so as to connect adjacent water tanks 1 to each other and make it possible to provide a foot bathing microbubble apparatus for multiple persons such as two persons or four persons.

A movable carriage 7 is fixed to the bottom portion 15 of the water tank 1.

A water drain valve 9 is provided at a rear portion 17 of the water tank 1.

Although not shown in the figure, the water tank 1 is provided with a heater for heating hot water and the like in the water tank main body 1A, for example, in the low chamber 1D.

A timer is provided which controls the operation of the foot bathing microbubble apparatus.

Furthermore, a switch is provided which can control the jetting pressure, flow rate or liquid temperature of liquid containing microbubbles of the foot bathing microbubble apparatus.

The number of the microbubble generating devices is equal to six, and by setting the volume of the water tank 1 to about 20 liters, the volume per microbubble generating device can be set to about 3.3 liters.

The other configurations are similar to those of the above embodiment.

According to the foot bathing microbubble apparatus having the above configuration, the following effects are achieved.

(1) Since the opening portions 21 of the MB devices 2a face the ankles of the feet, the opening portions 21 of the MB devices 2b face the tops of the feet, and the opening portions 21 of the MB devices 2c face the toes of the feet, and the opening portions 21 are arranged so as to be able to perform proximate jetting to the feet, the jetting target T can be intensively exposed to microbubbles with a high density.
(2) The microbubbles are kept with high density in the water tank 1 by setting the volume of the water tank 1 per microbubble generating device to about 3.3 liters.
(3) The bottom surface 11 of the water tank main body 1A is formed to be sloped downward to the drainage port 8, so that drainage can be performed quickly and easily, and subsequent replacement of hot water or the like can be quickly performed.
(4) Since the movement of the water tank 1 is made easy by the movable carriage 7, the efficiencies of the drainage work and the replacement work of hot water or the like can be enhanced.
(5) The connecting portion 6 and the handle 60 make it possible to provide a foot bathing microbubble apparatus for multiple persons such as two persons or four persons, so that dialogue between jetting target persons advances and “life living type care bathing” can be established.

### Wheelchair Adaptable Foot Bathing Apparatus

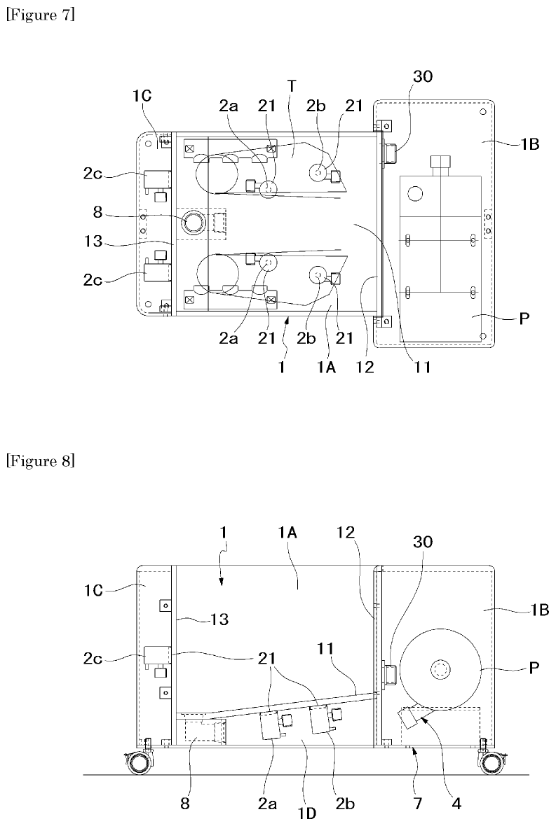

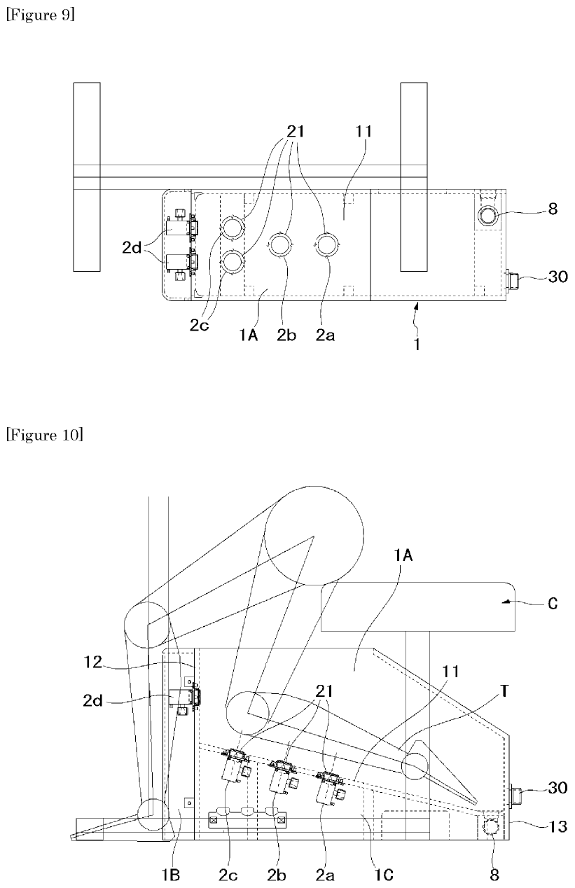

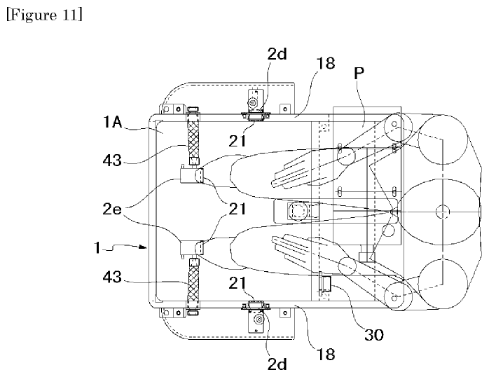

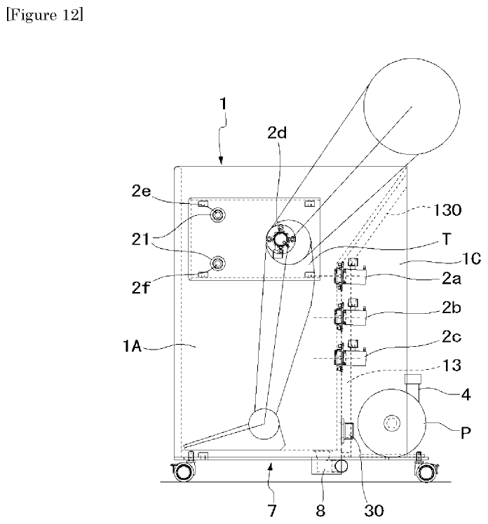

In a wheelchair adaptable foot bathing apparatus, as shown in FIGS. 7 and 8, when the water tank 1 and the feet of a jetting target person sitting on a wheelchair are accommodated in the water tank 1, the opening portions 21 of the plural MB devices 2 are arranged on the bottom surface 11 of the water tank 1 so as to face the undersides of both the feet, and the opening portions 21 are arranged on the rear surface 13 of the water tank 1 so as to face the Achilles tendons of both feet.

The water tank 1 includes the water tank main body 1A and the rear chamber 1C which can be inserted in a space under the seat surface formed between leg support pipes C1 (see FIG. 35) of the wheelchair which support below-knee portions of the jetting target person, and the front chamber 1B which is formed to be wide from an end portion of the water tank main body 1A and accommodates the pump P.

That is, the water tank main body 1A can be inserted in the space below the seat surface which is formed when the height thereof is set to about 39 centimeters or less while the width thereof is set to about 31 centimeters or the like, and foot rests C2 fitted to the tips of the leg support pipes C1 are folded.

The plural MB devices are arranged on the bottom surface 11 of the water tank main body 1A such that, for example, the opening portions 21 of the MB devices 2a face the back sides of the tops of the feet and the opening portions 21 of the MB devices 2b face the backs of the toes. Furthermore, the opening portions 21 of the MB devices 2c are arranged on the rear surface 13 of the water tank main body 1A so as to face the Achilles tendons of the rear portions of the feet.

The distance between each of these opening portions 21 and the jetting target T is set so that proximate jetting can be performed as in the case of the above embodiment.

According to the wheelchair adaptable foot bathing apparatus having the above configuration, the following effects are achieved.

(1) Since the water tank main body 1A can be inserted in the space under the seat which is formed when the foot rests C2 fitted to the tips of the leg support pipes C1 of the wheelchair are folded, the feet of the jetting target person sitting on the wheelchair can be accommodated in the water tank main body 1A as they are, and foot bathing can be performed in a comfortable posture.
(2) Since the opening portions 21 of the MB devices 2a are arranged on the bottom surface 11 of the water tank main body 1A so as to face the back sides of the tops of the feet, and the opening portions 21 of the MB devices 2b are arranged on the bottom surface 11 of the water tank main body 1A so as to face the back sides of the toes, the opening portions 21 of the MB devices 2c are arranged on the rear surface 13 of the water tank main body 1A so as to face the Achilles tendons of the rear portions of the feet, and the distance between each of these opening portions 21 and the jetting target T is set so that proximate jetting can be performed, the jetting target T can be intensively exposed to microbubbles with high density.
(3) Miniaturization of the water tank main body 1A so as to place the water tank main body 1A under the seat portion of the wheelchair contributes to reduction in the volume of the water tank 1, so that microbubbles are kept with high density in the water tank 1.

The other configurations and effects are similar to those of the above embodiment.

### One-Knee Bathing Microbubble Apparatus

As shown in FIGS. 9 and 10, in a one-knee bathing microbubble apparatus, for one knee of a jetting target person of a jetting target T accommodated in the water tank 1, plural MB devices 2 are arranged so as to face the one knee, and the opening portions 21 are fitted to the bottom surface 11 and the front surface 12 of the water tank 1 so as to face the one knee.

The main body 1A of the water tank 1 is provided with the bottom surface 11 inclining gradually downward from the kneecap to the tiptoe so that one knee of the jetting target person sitting on a dedicated chair C (see FIG. 39) is accommodated in a partially folded state.

Note that the pump P is arranged below the dedicated chair C.

Among the plural MB devices 2, the MB devices 2a and 2b are arranged on the bottom surface 11 of the water tank main body 1A, for example, so that the opening portion 21 of the MB device 2a faces a lower portion of the shin of the knee, and the opening portion 21 of the MB device 2b faces an upper portion of the shin of the knee. Furthermore, the two MB devices 2c and 2c are arranged on the bottom surface 11 so that the respective opening portions 21 of the two MB devices 2c and 2c face the kneecap of the knee, and the two MB devices 2d and 2d are arranged on the front surface 12 of the water tank main body 1A so that the respective opening portions 21 of the two MB devices 2d and 2d face an upper portion of the kneecap of the knee.

As in the case of the above-described embodiment, the distance between the opening portion 21 and the jetting target T is set so that the proximate jetting can be performed, and the respective opening portions 21 of the MB devices 2c and 2c and the MB devices 2d and 2d are arranged around the kneecap, so that the effect of the proximate jetting can be enhanced.

Note that the number of the microbubble generating devices is six, the volume of the water tank 1 is about 30 liters, and the volume per microbubble generating device described above is about 5 liters.

As shown in FIG. 39, the dedicated chair C has a seat portion C3 for supporting the buttocks of the jetting target person, and a slope portion C4 for supporting the chest of the jetting target person in a stooped state.

Although the movable carriage 7 is not particularly shown, the water tank 1 may be fixed to the dedicated chair C, and the movable carriage may be fitted to the dedicated chair C.

According to the one-knee bathing microbubble apparatus having the above configuration, the following effects are achieved.

(1) By combining the water tank 1 and the dedicated chair C, the jetting target person can keep a relax posture even when one knee of the jetting target person is accommodated in the water tank 1 while partially folded.
(2) Since the respective opening portions 21 of the MB devices 2c and 2c and the MB devices 2d and 2d are arranged around the kneecap, the kneecap can be intensively exposed to microbubbles with high density.

The other configurations and effects are similar to those of the above embodiment.

### Both-Knees Bathing Microbubble Apparatus

As shown in FIGS. 11 and 12, in a both-knees bathing microbubble apparatus, for the knees of a jetting target person of a jetting target T accommodated in the water tank 1, the opening portions 21 are arranged on the rear surface 13 of the water tank main body 1A, and the opening portions 21 are arranged to face the front sides of both the knees via flexible tubes 43.

In the water tank 1, a sloped surface 130 is formed on the rear surface 13 of the water tank main body 1A so that the knees of the jetting target person sitting on a chair can be accommodated with a margin.

The MB devices 2a to 2c arranged so that the opening portions 21 face the calf of the knee of the left leg are vertically fixed to the rear surface 13 of the water tank main body 1A.

The MB device 2d arranged so that the opening portion 21 faces a side portion of the kneecap of the left leg, and the MB devices 2e and 2f in which the opening portions 21 can be adjusted to perform proximate jetting on the front portion of the knee via the flexible tubes 43 are respectively fixed to the side surface 18 of the water tank main body 1A.

The arrangement of the opening portions 21 for the knee of the right leg is the same.

Note that the pump P is arranged in the rear chamber 1C of the water tank 1.

According to the both-knees bathing microbubble apparatus having the above configuration, the following effects are achieved.

(1) Since the opening portions 21 are arranged to face the front sides of both the knees via the flexible tubes 43, microbubbles can be proximately jetted to any place centered on the kneecaps by operating the flexible tubes 43.

The other configurations and effects are similar to those of the above embodiment.

### Upper Limb Care Bathing Apparatus

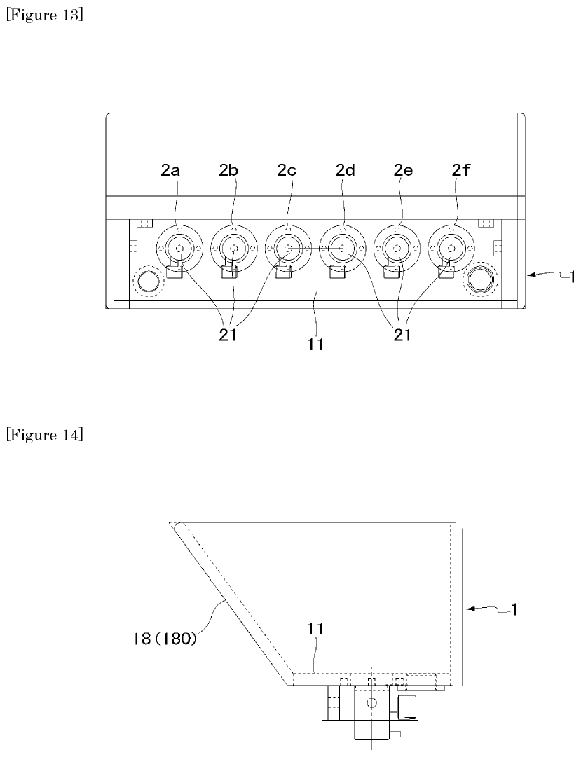

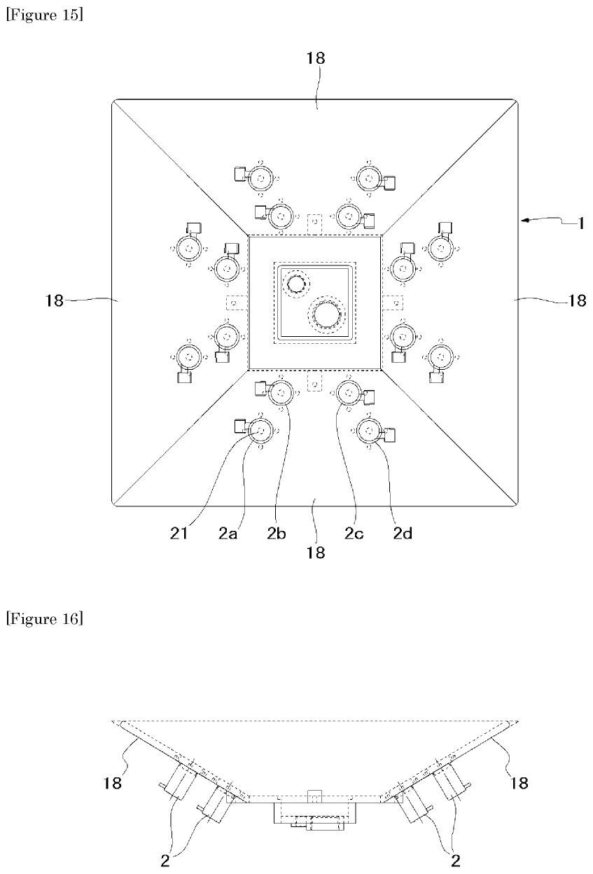

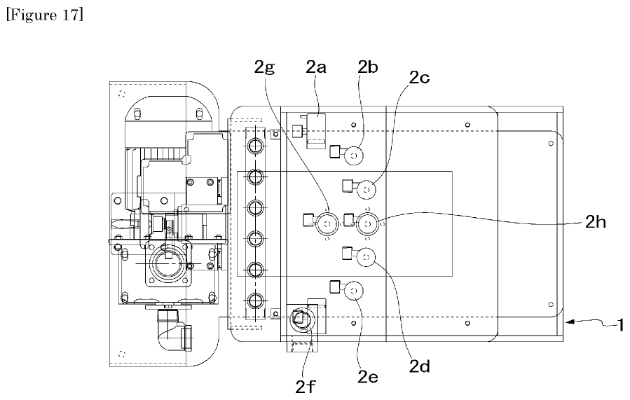

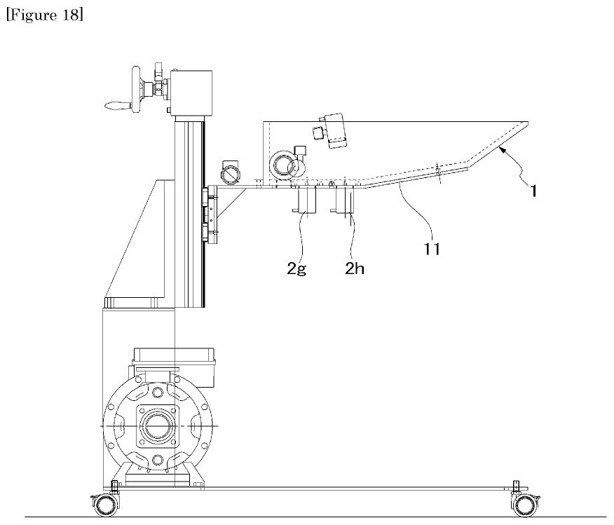

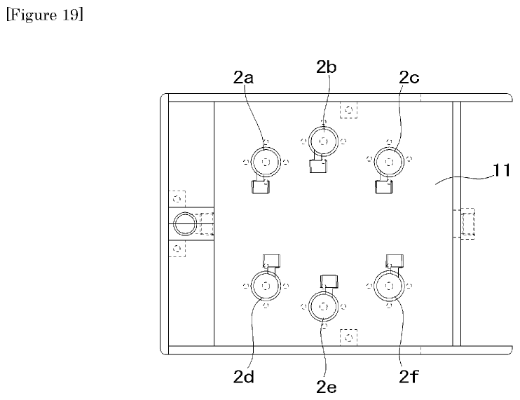

As shown in FIGS. 13 and 14, in an upper limb care bathing apparatus, for the upper limbs of a jetting target person of a jetting target T accommodated in the water tank 1, plural MB devices 2a to 2f are arranged in the longitudinal direction of the upper limb from the fingers to the elbow, and the opening portions 21 are arranged on the bottom surface 11 of the water tank 1 so as to face the upper limb.

The water tank 1 has a sloped surface 180 obtained by inclining a side surface 18 in contact with a wheelchair outward (to the side of the jetting target person) so that the upper limb can be put into the water tank 1 while the jetting target person sits on the wheelchair.

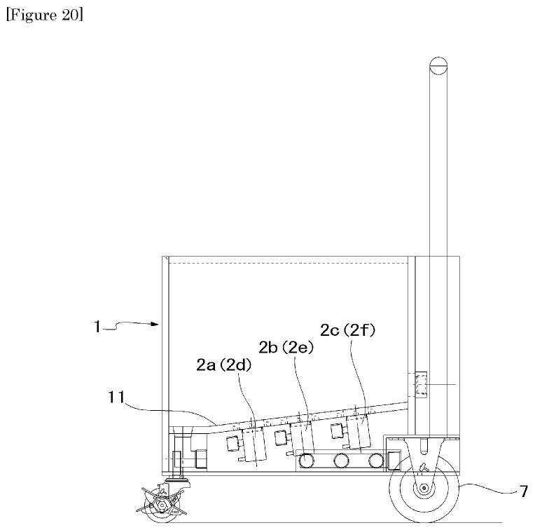

In the upper limb care bathing apparatus, as shown in FIGS. 15 and 16, the jetting target accommodated in the water tank 1 may be the upper limbs of plural jetting target persons. In this case, the MB devices 2a to 2d are arranged on plural side surfaces 18 of the water tank 1 so that the respective opening portions 21 of the MB devices 2a to 2d can face the respective upper limbs.

In an upper limb care bathing apparatus of another example, as shown in FIGS. 17 and 18, for the upper limbs of a jetting target person of a jetting target T accommodated in the water tank 1, the respective opening portions 21 of the MB devices 2a to 2f are arranged to face the upper limbs of the jetting target person so as to enable proximate jetting of microbubbles via flexible tubes 43 (see FIG. 56 and FIG. 57). In addition, respective opening portions 21 of MB devices 2g and 2h are arranged on the bottom surface 11 of the water tank 1.

Note that in the upper limb care bathing apparatus, the number of microbubbles generating devices 2 is eight, the volume of the water tank 1 is about 8 liters, and the volume per microbubble generating device is about 1 liter.

According to the upper limb care bathing apparatus having the above configuration, the following effects are achieved.

(1) By proximately jetting microbubbles to an arm, the microbubbles can be jetted and fluidized around the arm to increase buoyancy on the arm, which relieves the mind and body of the jetting target person.
(2) When plural jetting target persons can use the upper limb care bathing apparatus at the same time, dialogue between jetting target persons advances, and “life living type care bathing” can be established.
(3) Microbubbles are proximately jetted to the upper limb accommodated in the water tank 1 by operating the flexible tubes 43, whereby washing and warm bathing on the upper limb can be performed.

The other configurations and effects are similar to those of the above embodiment.

### Hand Washing Apparatus

Although illustration is omitted, substantially as in the case of the upper limb care bathing apparatus, in a hand washing apparatus, for the hand of the jetting target person of the jet target T accommodated in the water tank 1, the opening portions 21 are arranged on the bottom surface 11 of the water tank 1, and are arranged to face the hand of the jetting target person so as to enable proximate jetting of microbubbles via the flexible tubes 43.

This hand washing apparatus also has a rear surface 13 sloped outward so that the hand can be put into the water tank 1 while the jetting target person sits on a wheelchair.

According to the hand washing apparatus having the above configuration, the following actions and effects are achieved.

(1) Microbubbles are proximately jetted to fingers, palms, wrists, etc. accommodated in the water tank 1 by operating the flexible tubes 43, whereby washing and warm bathing for fingers, palms, wrists, etc. can be performed.
(2) By mixing a cosmetic solution with hot water in the water tank 1, it is possible to remove stains on fingers, palms, wrists, etc. and impart a moisturizing effect.

The other configurations and effects are similar to those of the above embodiment.

### Face Washing Apparatus

Although illustration is omitted, in a face washing apparatus, the opening portions 21 are arranged on the bottom surface 11 and the side surface of the water tank 1, and, substantially as in the case of the hand washing apparatus, the opening portions 21 are arranged to face the face of a jetting target person so as to enable proximate jetting of microbubbles via the flexible tube 43.

According to this face washing apparatus, microbubbles can be proximately jetted to each part of the face by operating the flexible tubes 43.

Furthermore, by mixing a cosmetic solution with hot water in the water tank 1, stains on the face can be removed and the moisturizing effect can be imparted.

The other configurations and effects are similar to those of the above embodiment.

### Delivery Foot Bathing Apparatus

A delivery foot bathing apparatus is configured by providing a water tank 1 for foot bathing and a pump P for feeding pressurized liquid to the microbubble generating devices 2 arranged in the water tank 1 on separate movable carriages 7, respectively (see FIG. 63).

In the water tank 1, as shown in FIGS. 19 and 20, the respective opening portions 21 of the MB devices 2a to 2f are arranged on the bottom surface 11.

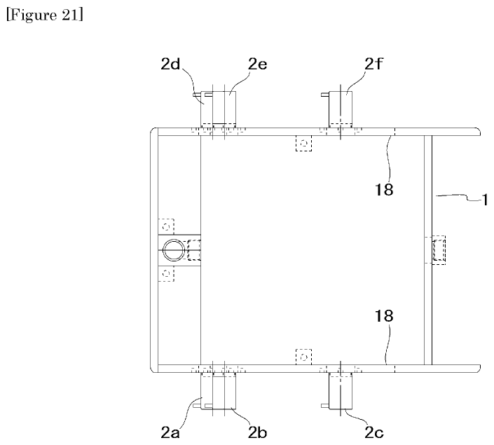

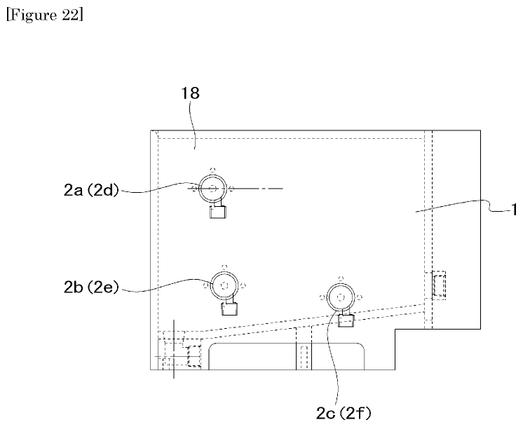

Furthermore, as shown in FIGS. 21 and 22, the respective opening portions 21 of the MB devices 2a to 2f are arranged on the side surface 18 of the water tank 1 of another example.

According to this delivery foot bathing apparatus, the weight of the foot bathing apparatus is dispersed to the water tank 1 and the pump P, so the mobility thereof is enhanced.

The other configurations and effects are similar to those of the above embodiment.

### Pet Washing Apparatus

Although illustration is omitted, in a pet washing apparatus, the microbubble generating devices 2 are fitted to the bottom surface and the side surface of the water tank 1, and the opening portions 21 are arranged to face a pet accommodated in the water tank 1.

According to this pet washing apparatus, by mixing a small amount of shampoo solution with hot water in the water tank 1, it is possible to not only wash the pet, but also promote the health of the pet.

### First Example (Example Related to Mechanical Bathing Apparatus)

This example and the subsequent examples had been carried out in the nursing home health facilities “N” (hereinafter referred to as “facilities N”) located in Oita Prefecture, etc., and data of experimental results (experimental data) had been collected in cooperation with the residents of facilities N.

Among the experimental data obtained in each example, description on photographs, etc. of bodies of subjects is omitted from the viewpoint of the nature of the specification because they relate to the privacy of the subjects, and only the experimental results are described.

In a first example, forty microbubble generating devices (made of stainless steel) were installed in an existing mechanical bathing apparatus of the facilities N.

A method of installing these microbubble generating devices, installation intervals thereof, etc. were set in conformity with FIG. 1, and it was considered that microbubbles were uniformly distributed in a bathtub. Furthermore, in connection with this installation, storage places and storage methods for necessary pumps, power sources, etc. were determined.

That is, when bathing while sitting on a chair, simultaneous bathing of two persons was assumed, the arrangement was determined such that microbubbles were evenly jetted to both the persons.

The jetting of microbubbles in all the present microbubble generating devices are set to be performed in the upward direction.

Note that the volume of hot water in this mechanical bathing tank is about 2 m³, and the volume per microbubble generating device is about 50 liters. As a result, it is possible to perform microbubble washing over the entire body and improve rehabilitation bathing based on significant promotion of blood flow on the skin surface.

Here, the basics of a microbubble generating device used in the first example and each of the subsequent examples and the physicochemical properties of microbubbles will be clarified.

### (1) Microbubble Generating Device

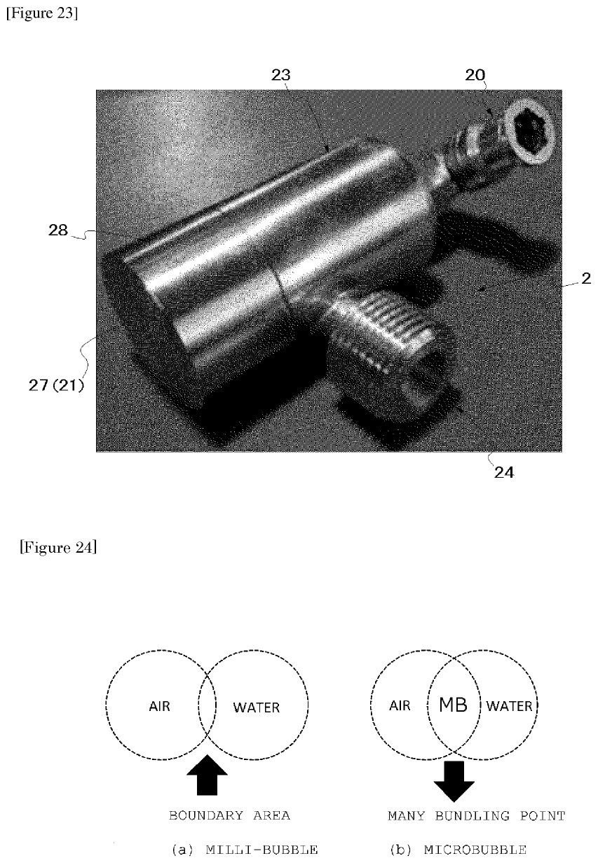

FIG. 23 shows the microbubble generating device. The feature of this device resides in that significant promotion of blood flow is realized and the jetting direction of microbubbles can be controlled. That is, the jetting of the microbubbles can be correctly performed frontwards.

At that time, since the size of pores at an outlet portion of the apparatus (opening portions 21) is an important factor, a test was also conducted to determine the pore size and number of the opening portions 21. In this case, when the pore size is too small, microbubbles do not appear, and when the pore size is too large, it is difficult to control high concentration solubility, and further it is impossible to control the jetting direction. Therefore, an optimum condition was searched.

Therefore, the pore diameter at the outlet portion of the apparatus was set to 1 mm, 1.5 mm, 2 mm, and 2.5 mm for examination, and 2 mm was determined as an optimum diameter. Furthermore, it was found that the blood flow promotion quantity varied according to change of the aperture rate at that pore diameter. Therefore, the aperture rate was defined as follows, and the application was performed according to the respective features.

Here, the aperture rate of 100% is defined as indicating a state where the number of pores at the outlet portion of the apparatus is 40.

Level 1: 100% to 70% in aperture rate; mild blood flow promotion standardizing that the blood flow promotion is 1.5 to 2.0 times as large as the blood flow promotion under normal bathing.

Level 2: 60% to 40% in aperture rate; significant blood flow promotion standardizing that the blood flow promotion is 2.0 to 4.0 times as large as the blood flow promotion under normal bathing.

Level 3: around 40% to 20% in aperture rate; significant blood flow promotion standardizing that the blood flow promotion is 4.0 to 5.0 times or more as large as the blood flow promotion under normal bathing.

### (2) Physicochemical Properties of Microbubbles

A microbubble technology is characterized in which both liquid and gas are utilized at a high level, and generation of lots of microbubbles in liquid has caused creation of a new law based on many bundling points in a remarkably broader boundary region in an action target object as compared with that in the past.

This enlargement of the boundary region has created an opportunity to find “giving a significance newly” such as “more greatly bringing out properties as gas even in liquid”, “more tinged with properties like liquid even in the case of gas” by microbubbling.

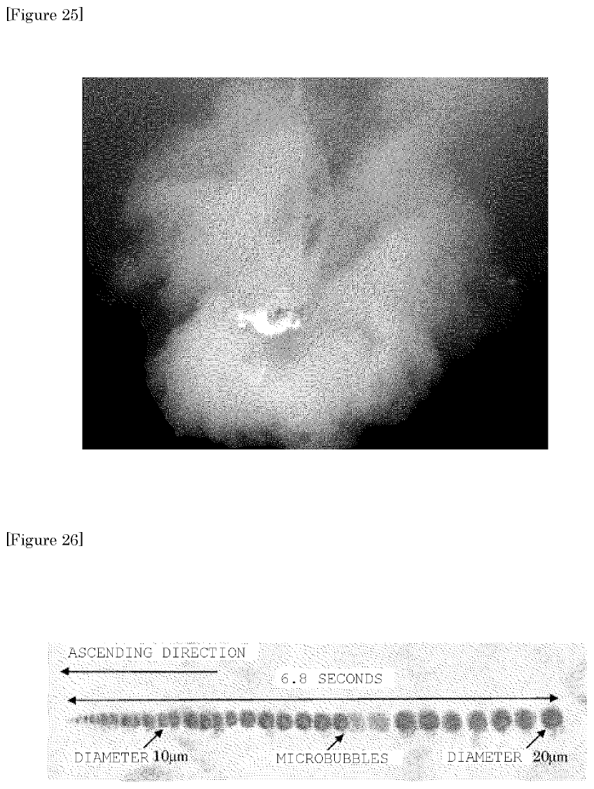

FIG. 24 is a conceptual sketch of the enlargement of the boundary region and the appearance of many bundling points. Naturally, due to this enlargement and appearance, microbubbles and liquid containing the microbubbles (referred to as “microbubble water”) have following unique physicochemical properties which are essentially different from those of conventionally widely used “milli-bubbles (which are bubbles having millimeter sizes in diameter) (see Hirofumi Taisei: “All of microbubbles”, Japan Business Publishing Co., Ltd., 2006).

(i) Contraction of microbubbles
(ii) Electrification of negative potential and increase of microbubbles
(iii) Light emission of microbubbles
(iv) Weak alkalization of microbubble water

FIG. 25 shows a state of lots of microbubbles generated in seawater. Most of the microbubbles initiate contraction immediately after the generation thereof, and then disappear and dissolve in liquid in a short time. In the contraction process, the microbubbles increase negative potential and repeat light emission. These are a series of phenomena, and there is a relationship in which the above (i) triggers and the phenomena of (ii) and (iii) concomitantly occur.

In connection with the contraction motion, “increase of temperature and pressure” is realized in the microbubbles, so that an important chemical reaction of (iv) occurs. Since the characteristics and processes described above affect the physiological activity of a human body to some extent as described later, these characteristics will be considered in more detail.

### (i) Contraction of Microbubbles

The reason why the contraction motion of microbubbles is considered to be one of the most important physical phenomena resides in creation of an opportunity for a series of processes in which the energy in the microbubbles gradually increases as the contraction motion is initiated, resulting in induction of a chemical reaction.

Therefore, it is important to pay attention to a matter that no chemical reaction occurs in microbubbles which do not contract or microbubbles having a low contraction speed, so that the basic properties of the microbubbles are largely varied.

On the other hand, the mode in a generation frequency distribution of microbubbles ranges from 20 to 40 μm, microbubbles having bubble diameters in this range account for about 60% of the whole, and these microbubbles shift to the contraction motion all together immediately after they are generated (see Hirofumi Taisei: “All of microbubbles”, Japan Business Publishing Co., Ltd., 2006).

FIG. 26 shows sequence photographs obtained by visualizing microbubbles generated in tap water at a magnification of about 800, and temporally tracking the microbubbles. As a result, the state clearly indicates that the microbubbles contract and disappear in a relatively short time.

The reason why the contraction motion of the microbubbles is initiated resides in that when microbubbles are generated in an ultrafast swirling microbubble generating device, a negative pressure of about −0.06 MPa is formed at a gas cavity portion formed in the vicinity of the central axis of the ultrafast swirling microbubble generating device, and the negative pressure is cut and crushed at an ultrafast swirling speed of about 500 revolutions per second to generate microbubbles (see Hirofumi Taisei: “All of Microbubbles”, Japan Business Publishing Co., Ltd., 2006).

Accordingly, it is natural to understand that the microbubbles just after generation thereof suffer this influence and thus have negative pressure therein. Furthermore, after the generation of the microbubbles, the microbubbles suffer an influence of positive pressure caused by ambient liquid and thus contraction is automatically initiated due to the pressure difference between the inside and the outside. Thereafter, it is observed that increase of temperature and pressure in the microbubbles progresses together with the contraction while the contraction and expansion caused by a counter action to the contraction are repeated, the microbubbles are more easily dissolved and the dissolution and the contraction are promoted. FIG. 27 shows a conceptual model of this process.

### (ii) Negative Potential Characteristics and Light Emission Phenomenon of Microbubble

The negative potential characteristic of the microbubbles is higher as the diameter is smaller, and a peak of about −40 mV is formed in the diameter range from about 10 to 30 This increase suggests that the energy in the microbubbles gradually increases with the progress of the contraction, and as a result, it is considered that thermal excitation of the microbubbles mainly links to the light emission phenomenon.

One of technically important matters resides in that the negative potential characteristic of microbubbles enhances detergency, and the microbubbles adhere to stains of organic materials having a positive potential and exfoliate the statins, thereby causing the functionality of high detergency. Furthermore, with respect to the light emission of (iii), attention has been paid to an action of removing fine organic materials as if the organic materials are “instantly burned” by the action of increasing the temperature and the pressure, and functionality such as an effect that high permeability is brought about due to appearance of this instantaneous temperature gradient.

FIG. 28 shows an example of an image at the moment when microbubbles emit light (this light emission characteristic is reviewed in some detail in a literature, Hirofumi Taisei: “What is optical microbubble”, Proceedings of Lectures of Micro-Nanobubble Technology Symposium, 48-53, 2007)

### (iv) Weak Alkalization of Microbubble Water

As shown in FIG. 29, it is known that when tap water is poured in a water tank and air microbubbles are continuously generated while the water is circulated, the solution tends to exhibit weak alkalization. However, the cause of this alkalization has been unknown for a long time, and it has been one of so-called “mysteries of microbubbles”.

The reason why it has been difficult to solve the mystery resides in that although it is instantaneous, it is not easy to image a phenomenon that temperature and pressure inside microbubbles are increased and a chemical reaction occurs to produce a synthetic substance, and thus it has been impossible to establish an analysis method for the phenomenon. However, the principal investigators of this application have discovered an alkalized substance produced in this microbubble water, and has filed a patent application thereon in 2011 (Hirofumi Taisei, et al.: Japanese Patent, Japanese Patent Laid-Open No. 2011-68555 in 2011).

The identity of this alkalized substance was a very small amount of ammonia. When the amount of ammonia is very small, it acts as a plant nutrition, and the optimum concentration thereof is said to be 0.3 ppm. The ammonia of the solution produced in FIG. 29 was nearly identical to this ammonia concentration. In the process of this generation of ammonia, it seems to be closely related to the biological activity of the above-described microbubbles, particularly, the blood flow promotion.

The bioactivity effect of microbubbles is also related to generation of nitric oxide in solution, and effects of vasodilation and blood flow promotion of this substance are noted.

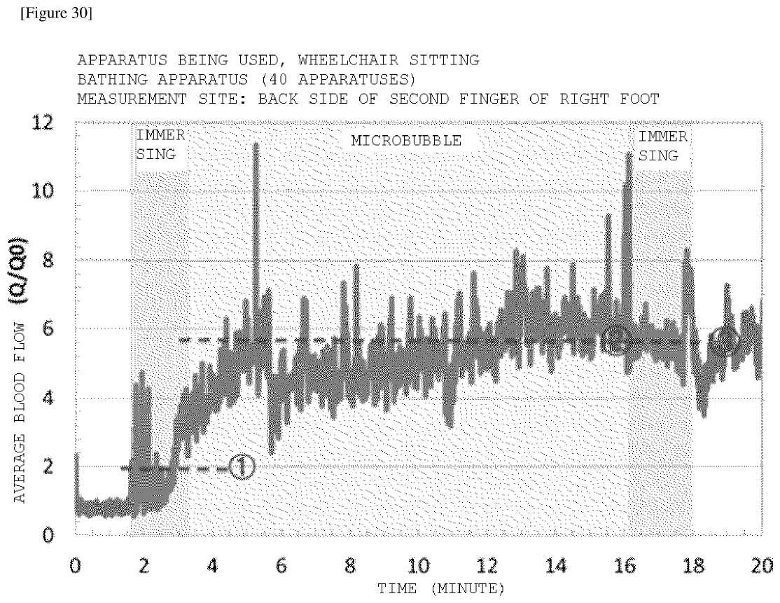

FIG. 30 shows a measurement result of blood flow promotion in the mechanical bathing apparatus. In this case, a subject was a man in the age of 40's. The liquid used was tap water, and the water temperature was about 40° C.±1° C. In this case, the ordinate axis represents the ratio of the average blood flow. The blood flow measured in the air is represented by Q₀, and the subsequently measured blood flow Q is divided by the value of Q₀ and represented in dimensionless fashion. After generation of microbubbles is initiated, the blood flow gradually increases, then becomes almost steady and indicates a constant value. When the average blood flow during this period is indicated by a dotted line (2), the blood flow promotion of about 2.9 times appears before and after microbubbles are generated during infiltration. Furthermore, after microbubbling is stopped, the average blood flow is almost equal to the value at the time when the microbubbles are generated, which indicates that a remaining effect of microbubbles exists even after the generation stops.

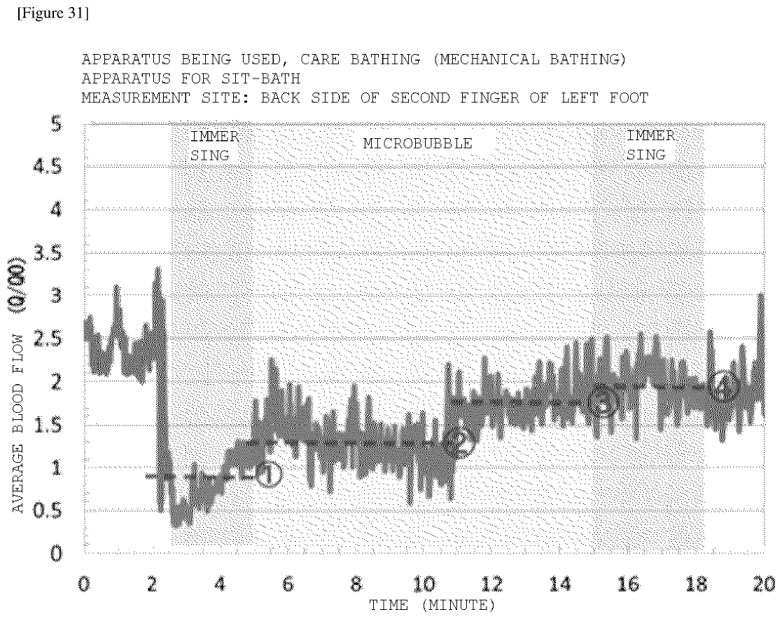

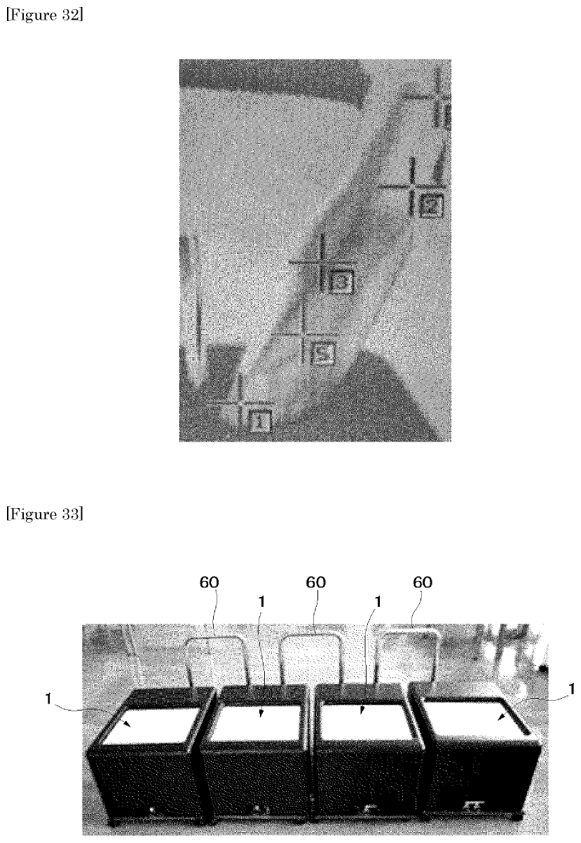

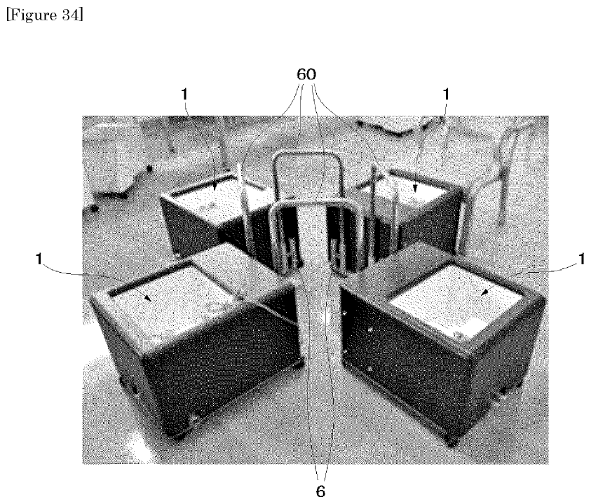

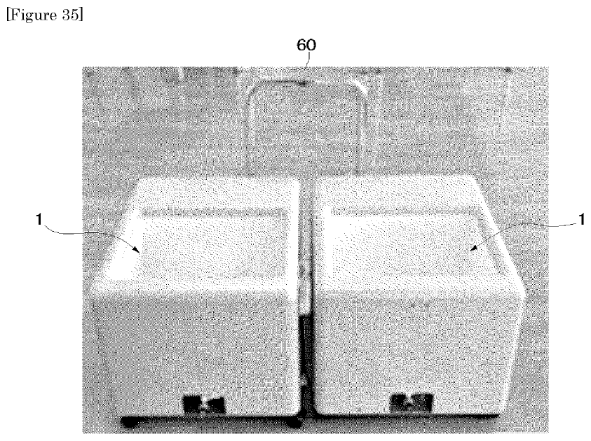

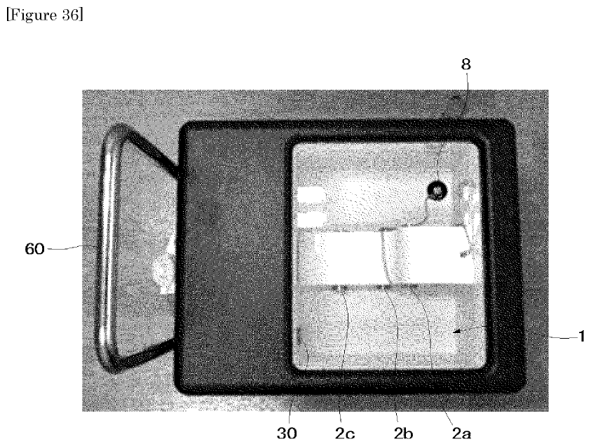

Next, FIG. 31 shows variation of blood flow of a woman in the age of 40's who was subjected to the same blood flow experiment in the same water tank under the same water temperature condition. In this case, the subject was a woman in the age of 40's. From FIG. 31, it is first noted that the blood flow in the air is large. However, this experiment was a first blood flow measurement in a swimsuit, and it seems that her psychological excitement induced the large blood flow. However, after infiltration, the waveform of the blood flow becomes steady and exhibited a downward tendency. In this case, the value of Q₀ is not a value measured in the air, but is set as a blood flow before generation of microbubbles after infiltration, and the ordinate axis is made dimensionless with the value. Therefore, an accurate average blood flow at this infiltration time was more accurately calculated, and this value was set as the height of a dotted line (1). Thereafter, it is apparent that the blood flow gradually increased after the generation of microbubbles, and the height changed in two steps of dotted lines (2) and (3). Such a long-period variation is considered to be a phenomenon that occurred because the water tank was large and thus a flow pattern in the water tank slowly varied.

Therefore, when the respective ratios of the dotted lines (2) and (3) to the dotted line (1) are calculated, the blood flow promotion ratios are 1.7 times and 2.1 times, respectively. It is apparent that after the generation of microbubbles stopped, the blood flow promotion quantity further increased more than that of the dotted line (3), and the effect of microbubbles appeared also after the stop. Note that cases where a measuring unit was exposed to the air at the beginning of the experiment and at the end of the experiment respectively are compared with each other, the blood flow in the latter is smaller, and from this point, it is also guessed that her considerable tension affected the variation before the experiment was started.

As described above, according to results of the blood flow measurement in FIGS. 30 and 31, it is apparent that in this care bathing, a blood flow promotion ratio of 1.5 to 3 times of that of the normal bathing (only hot-water bathing with no microbubble) which was an initial target was almost achieved in the blood flow promotion effect based on microbubbles.

The present research and development are based on vasodilation of peripheral blood vessels by microbubbles and the phenomenon that a significant blood flow promotion action induced by the vasodilation occurs. This action occurs as a result of “nitric oxide (NO)” produced by subjecting nitrogen contained in the air to dissolution and chemical synthesis by microbubbling and strong electrostatic friction occurring at the interface of gas-liquid two-phase fluid of water and air by swirling the gas-liquid two-phase fluid of water and air at an ultrafast speed of about 500 revolutions per second.

By inducing this blood circulation, “circulation of blood” in the whole body is enhanced, and it is possible to improve hardening and cooling of muscles and warm the whole body.

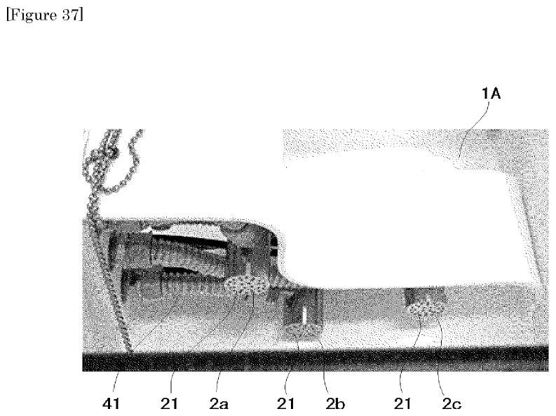

FIG. 32 shows an example of the latest result on blood flow promotion by the vasodilation of the blood vessels which was obtained by joint research with a surgical hospital located in Oita Prefecture.

That is, FIG. 32 shows an infrared camera image showing the state of an experiment of blood flow promotion by microbubbles. The temperature is higher as the color is redder, and the temperature in the lower water tank is 40° C. As the color shifts to green color and blue color in this order, it indicates lower temperature.

In this case, the subject was a healthy therapist. This photograph is a photograph of an upper limb during microbubble bathing, and is an infrared camera image at that time. It is apparent that microbubbles were jetted to a back portion of a hand infiltrated with hot water (40° C.), so that the blood vessels of an arm were expanded and greatly swelled and floated up from the skin surface (naturally, such swelling caused by vasodilation did not appear prior to the experiment).

It is noted from the infrared camera that the swelling blood vessel portion is hotter as compared to surroundings thereof and thus projected as a red area. This suggests that the significant promotion of blood circulation by the microbubbles was brought about by vasodilation, and blood warmed at the back portion of the hand flowed into the blood vessels of the venous system and went from the arm to the heart, thereby enhancing so-called “circulation of blood” throughout the whole body.

At the same time, it has been greatly noted that superior physicochemical properties (heat, negative potential, light emission, chemical reaction, etc.) of microbubbles enhances sensory nerve stimulation of cells and a transmission characteristic thereof, thereby actively stimulating the brain, so that unique brain reactions (sleeping, relaxing, feeling of fullness, progress of bright conversation, etc.) occur.

Since microbubbles are excellent in cleaning of very small polluted particles of organic materials and oils and they are actively used to clean semiconductors and machine parts, microbubble bathing can remove fine dirt on human bodies and keep the surfaces of skins always clean. In addition, microbubble water is excellent in moisture retaining property because it exhibits excellently high permeability into cells, and it exhibits a characteristic that the skin of a bather comes to shine well (especially, this is remarkable at the undersides of feet, palms, faces, etc. because they have many blood vessels).

Water and air required for generation of microbubbles are typical “bioadaptive substances” on the earth, and it has been confirmed in many biological fields that they are safe and secure materials producing no side effect.

In the foregoing first example 1, the significant blood flow promotion result of 1.5 to 3 times was obtained as compared with the case of the normal bathing (mere hot-water bathing having no microbubble). In addition, it was also observed that the present care bathing finely cleaned the skin surface and made the color and gloss of the skin better. Furthermore, it was confirmed from many subjects that walking after bathing became smoother by repeating this bathing.

### Second Example (Example of Foot Bathing Microbubble Apparatus)

FIGS. 33 and 34 show a four-person set unit of foot bathing microbubble apparatuses, and FIG. 35 also shows a two-person set unit of foot bathing microbubble apparatuses.

The four-person set unit shown in FIG. 34 can also be used as a four-way face-to-face type, and it is also used as a unit in which four-person circle conversation is established.

The apparatus of the example includes six microbubble generating devices, and adopts a method of jetting microbubbles horizontally from the sides to the feet placed in the water tank. In this case, places at which the microbubbles are jetted are near to the big toes, portions under the ankles, the insides of the calves, and they are portions where pain is likely to occur when the feet are bad. An object is to induce blood flow promotion by proximately jetting microbubbles to these portions, thereby softening muscles and relieving pain and body cold.

As shown in FIGS. 36 and 37, the apparatus includes a pipe for drainage, a foot bathing water tank at a center portion, a black box containing a pump at the back side, and a handle 60 for transportation at the backmost side. A portion in which six microbubble generating devices are arranged is provided at the center portion of the water tank 1, and a partition plate is arranged above the above portion.

An arrangement is devised so that microbubbles are jetted in contiguity with vicinities of the insides of the thumbs of feet, vicinities of insides of the arches of the feet, and vicinities of the ankles of the feet from the right. It is noteworthy that a very small and compact specification of 570 mm width×400 mm height×450 mm depth is realized as the overall size. In addition, the appearance is a soft design using a curve, and it is finished in an easy-to-use manner.

The level of blood flow promotion by microbubbles were classified into two levels, and the action and effect were examined based on Level 1 and Level 2. In this case, the difference between levels 1 and 2 is the difference in the blood flow promotion quantity, and it has been clarified that the adjustment on the blood flow promotion quantity can be controlled by the aperture rate of the microbubble generating devices. A blood flow promotion experiment was performed in consideration of an adjustment result of the blood flow promotion quantity. Actually, it was important that a test was first performed with a somewhat low blood flow promotion quantity (level 1), and the level was increased according to the patient's condition.

In consideration of the foregoing, Table 1 shows the number of microbubbles generating devices deployed in the foot bathing apparatus for each apparatus, an achieved level, a blood flow promotion target quantity, and properties.

TABLE 1

| APPARATUS | | | BLOOD FLOW | |
|---|---|---|---|---|
| NUMBER/APPARATUS | NUMBER OF | ACHIEVED | PROMOTION | |
| NAME | MB DEVICES | LEVEL | QUANTITY | PROPERTIES OF APPARATUS |
| (NUMBER OF USERS) | (NUMBER) | (LEVEL) | (Qₘ/Q₀) | (MAIN APPLICATION) |
| 2-1 FOOT BATHING | 24 | LEVEL 2 | 2 to 4 | BLOOD FLOW |
| MICROBUBBLE APPARATUS | | | | PROMOTION/WASHING/IMPROVEMENT |
| (FOR FOUR PERSONS) | | | | OF WALKING ABILITY, ETC. |
| 2-2 FOOT BATHING | 12 | LEVEL 2 | 2 to 4 | BLOOD FLOW |
| MICROBUBBLE APPARATUS | | | | PROMOTION/WASHING/IMPROVEMENT |
| (FOR TWO PERSONS) | | | | OF WALKING ABILITY, ETC. |
| 2-3 FOOT BATHING | 6 | LEVEL 2 | 2 to 4 | BLOOD FLOW |
| MICROBUBBLE APPARATUS | | | | PROMOTION/WASHING/IMPROVEMENT |
| (FOR ONE PERSON) A | | | | OF WALKING ABILITY, ETC. |
| 2-4 FOOT BATHING | 6 | LEVEL 1 | 1.5 to 2 | BLOOD FLOW |
| MICROBUBBLE APPARATUS | | | | PROMOTION/WASHING/IMPROVEMENT |
| (FOR ONE PERSON) B | | | | OF WALKING ABILITY, ETC. |

(Qₘ: blood flow under supply of microbubbles, Q₀: blood flow under normal bathing (no microbubble))

### (1) Person A in Need of Care

A was a woman in the age of 70's who was being hospitalized at the facilities N. She has bad feet, has difficulty in bipedal walking, and lives with a wheelchair. A blood flow sensor was placed on the back side of the second finger of the left foot and the microbubble blood flow experiment was performed. The water temperature was set to 40° C. A blood flow meter used in this experiment was a laser mutation type blood flow meter (manufactured by Omega Flow Co., Ltd.), and the blood flow sensor was based on an optical fiber and had been previously confirmed to operate normally in water. In addition, the blood flow in peripheral blood vessels below the skin surface was accurately measured by this blood flow meter.

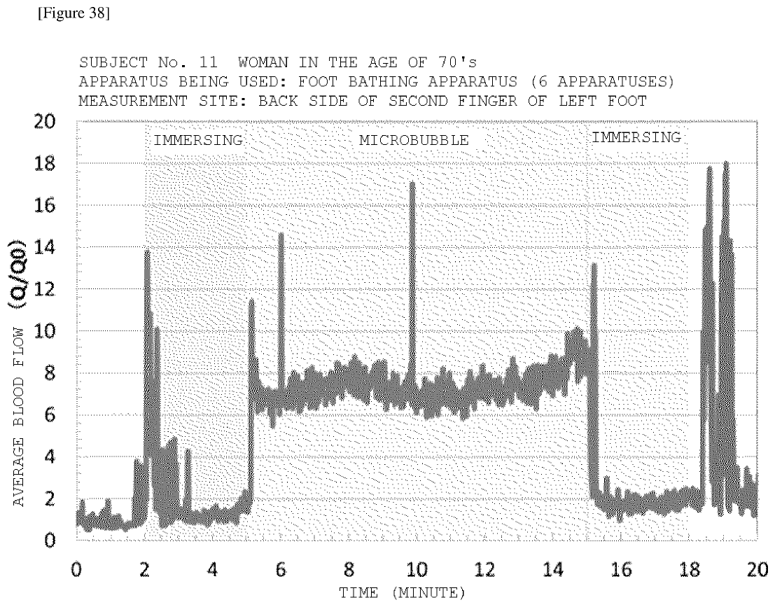

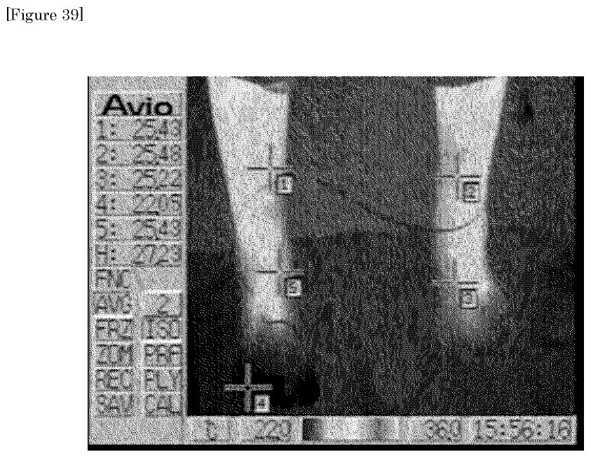

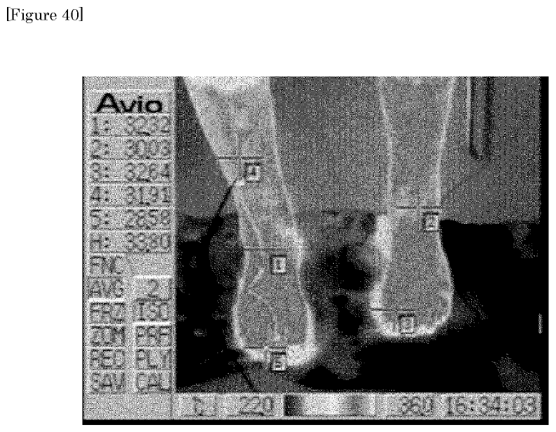

FIG. 38 shows a blood flow measurement result. The ordinate axis represents a blood flow, and the abscissa axis represents a lapse time. The blood flow on the ordinate axis is a dimensionless value obtained by defining a blood flow measured for feet placed in the air as Q₀ and dividing by Q₀. After lapse of about 2 minutes in the air, the feet were placed in hot water at about 40° C. and immersed for 3 minutes, and then microbubbles were generated for about 10 minutes. Thereafter, the generation of microbubbles was stopped, and after 3 minutes had elapsed in the immersed state, the feet was pulled out and left for 2 minutes.

As a result, it is apparent that simultaneously with the generation of microbubbles, the blood flow increased rapidly, reached 6 times as compared with a case using no microbubble, and during generation of microbubbles, gradually increased from that value up to 9 times. Such significant blood flow promotion is not induced by an action such as simple warming or administration of drugs, so that the unique feature of microbubbles is recognized here.

It is noteworthy that after that, when the generation of microbubbles was stopped, the blood flow decreased rapidly, but did not drop to the blood flow before the generation of microbubbles, and the value of about two times was maintained, so that the effect of the blood flow promotion by microbubbles remained.

In FIG. 38, another important feature is that the amplitude of the blood flow waveform is greatly different between the generation time of microbubbles and before and after the generation of microbubbles. Since it has been confirmed in another experiment that the blood flow waveform is coincident with the pulse of the heart, this amplitude is considered to be caused by the pulse oscillation of blood flow fed out from the heart. Since this increase in amplitude is about twice when comparing the amplitude at the generation time of microbubbles with that before and after that time, the increase in amplitude seems to mean that not only the blood flow is significantly increased by the generation of microbubbles, but also blood from the heart is fed out as larger pulses.

### (2) Person B in Need of Care

A person B in need of care was an 84-year-old woman admitted to the facilities N. She has bad feet, has difficulty in bipedal walking, and lives with a wheelchair.

FIGS. 39 and 40 show infrared camera images before and after supply of microbubbles. As is apparent from the comparison of the two images, the temperature of the impaired fingers of the right feet was low and the temperature of the tips thereof was 22° C. before supply of microbubbles.

However, after supply of microbubbles, it is apparent that the temperature of the skin surface rises up in both the right and left feet, and the value thereof also exceeds 30° C. From these facts, it is noteworthy that the effect of microbubbles works more effectively at a site where blood flow stagnates because there is a disorder, and the residual effect also appears more notably at a disordered site.

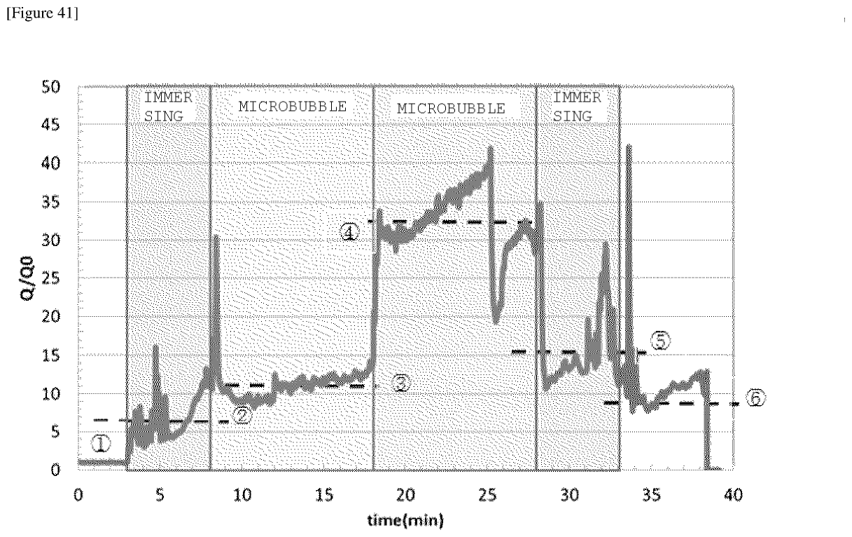

Referring to FIG. 41, the blood flow in the air (the blood flow Q₀ indicated by (1)) is used as a reference. When the feet are infiltrated with hot water of 40° C., the blood flow of the middle finger of the right feet reaches about 6.5 times (dotted line (2)). Thereafter, when milli-bubbles (also referred to as “macrobubbles”) are generated, the blood flow indicates a value of about 1.7 times as compared with the blood flow of the dotted line (2). This value is slightly larger than that in the case of healthy people. Since a state where reduction of blood flow occurs is originally maintained in the handicapped, this reduction of blood flow seems to appear as slight blood flow promotion.

However, when the generation of milli-bubbles is switched to the generation of microbubbles, the blood flow indicates about 5 times (dotted line (4)) as compared with the value of the dotted line (2). Even after the supply of microbubbles is stopped, the effect of the microbubbles remains, and the value thereof indicates that an effect of about two times (dotted line (5)) is maintained in water as compared with the value of the dotted line (2). Furthermore, in the air, a blood flow promoting effect of about 8 to 9 times (dotted line (6)) is obtained as compared with the blood flow of the symbol (1).

### (3) Elderly Person C

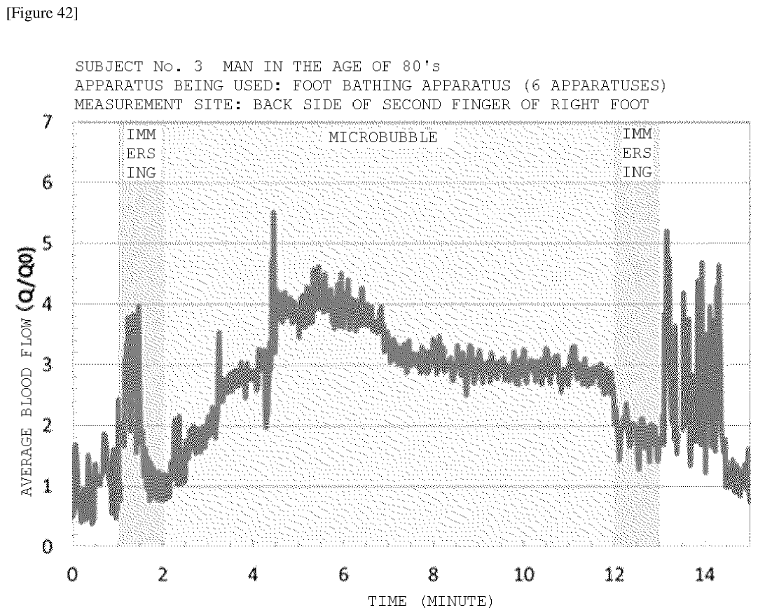

FIG. 42 shows a blood flow promotion effect in an elderly person C. C is a man, his age is in the 80's, and he can walk normally. The blood flow measurement was performed under the same experimental conditions by using the experimental apparatus in the above case. Although there was a disturbance when C placed his feet into the water tank because a mechanical vibration was applied to a measurement sensor when the feet were placed in the water tank, a microbubble experiment was started after blood flow data decreased. After the start, the blood flow gradually increases, indicates 4 times as a maximum value before or after lapse of 5 minutes, and then becomes steady at the value of 3 times. The blood flow remains twice even after microbubbling is stopped, and a continuous effect of the microbubbles appears.

As described above, it is clear that a significant blood flow promotion effect by microbubbles appears in this case as well.

### (4) Person D in Need of Care

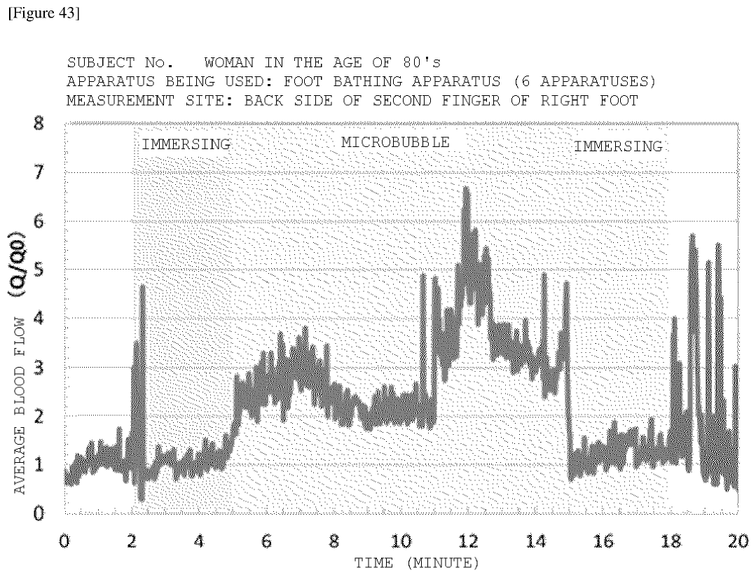

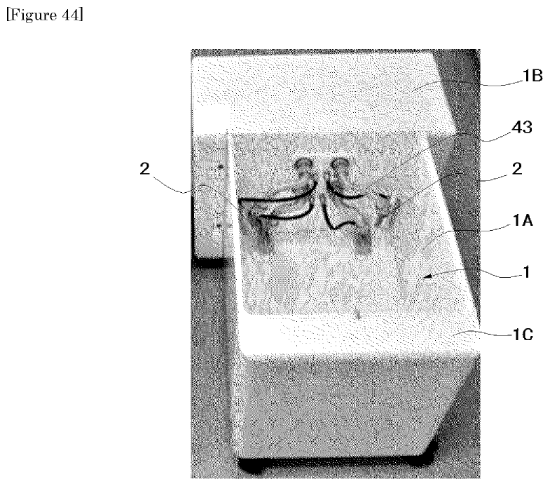

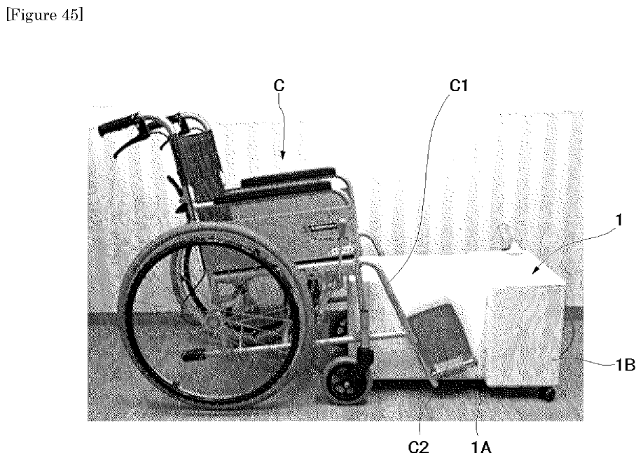

FIG. 43 shows a blood flow promotion result in the case of a person D in need of care. D is a man, and his age is in the 80's. He can normally walk. A blood flow measurement was performed under the same experimental condition by using the experimental device in the above case. It is apparent that the blood flow is not so varied between the infiltration with air and the infiltration with hot water. Subsequently, when microbubbles are generated, the increase in blood flow is about 2 to 3 times with fluctuation until lapse of 11 minutes, but then the blood flow exhibits a tendency of increasing from 3 to 6 times. After microbubbling is stopped, a sustained effect is small, and indicates about 1.5 times.

Thus, in the case of the person D in need of care, the blood flow promotion effect based on microbubbles of 2 to 6 times is recognized.

In the foot bathing apparatus, when microbubbles were generated, the significant blood flow promotion action was observed, and the promotion quantity thereof reached about 2 to 6 times even under the “level 1” experimental condition as compared with the blood flow under the same condition in the normal case of no microbubble. In addition, it was also confirmed that the blood flow promotion effect appeared more prominently in the impaired foot. This seems to suggest that some blood flow disorder has occurred at an impaired portion and thus microbubbles provide a blood flow promotion action compensating for the blood flow disorder.

All the subjects recognized “comfort” by the significant blood flow promotion action, and said “feel good”. In addition, there were many cases where they felt their feet lighter and walking easier. There also appeared such a case that it had been impossible to raise a hand, but it was possible to raise the hand more highly than before. These cases suggest that the effect of physical improvement, that is, life rehabilitation by microbubbles is not small.

Sensory nerve stimulation and thermal action and effect by microbubbles have been revealed by picking up infrared camera images, and the results thereof have been elucidated in correlation with the blood flow promotion.

The blood flow promotion experiments using microbubbles were performed on not only the persons in need of care, but also therapists as caregivers, and the effect thereof was actually experienced. As a result, the therapists' understanding of microbubbles was deepened, and the therapists felt their own bodies lighter, so that fatigues in care were reduced. In consideration of these matters, the present foot bathing apparatus is useful for both the persons in need of care and the caregivers.

The comparative experiments on the blood flow promotion quantity caused by the generation of macrobubbles and microbubbles were conducted, and the superiority of the bathing apparatus using the microbubble generating device was confirmed.

### Third Example (Example of Wheelchair Adaptable Foot Bathing Apparatus)

A “normal type” shown in FIGS. 7 and 8 and a “deep type” shown in FIG. 44 were prepared as a wheelchair adaptable foot bathing apparatus according to a third example. The difference between these apparatuses resides in the proximate jetting direction of the microbubble generating device. In the former, at the bottom portion of the water tank, four microbubble generating devices are installed at positions where a foot portion is assumed, and also microbubble generating devices are arranged so that microbubbles are jetted from the wall surface to the vicinities of the Achilles tendons.

In the “deep type” wheelchair adaptable foot bathing apparatus, a pump and the like are accommodated in a white box at an upper portion. Four microbubble generating devices are arranged with flexible tubes 43 on the side surface of the back side of the water tank so as to enable proximate jetting of microbubbles to the toes of the feet. In addition, two microbubble generating apparatuses are arranged on the wall surface so that microbubbles are jetted to the vicinities of the Achilles tendons from the microbubble generating devices. Furthermore, the bottom portion of the water tank is formed as a curved wall so that the feet can be easily placed, and the bottom is more lowered and the water depth increases as it gets closer to the front side of FIG. 44.

Note that a wheelchair adaptable foot bathing apparatus (normal type) -A assumes more severely disabled persons, and adjusts the microbubble devices so as to set the level of the blood flow promotion quantity to a mild effect (level 1). A wheelchair adaptable foot bathing device (normal type)-B assumes more mildly disabled persons, and adjusts the microbubble devices so as to set the level of the blood flow promotion quantity to a hard effect (level 2). This present apparatus is used exclusively for skin disease patients to prevent infections such as tinea. A wheelchair adaptable foot bathing apparatus (normal type) -C assumes more mildly disabled persons, and adjusts the microbubble devices so as to set the level of the blood flow promotion quantity to a hard effect (level 2). A wheelchair adaptable foot bathing apparatus (deep type) -D assumes more severely disabled persons, and adjusts the microbubble devices so as to set the level of the blood flow promotion quantity to a mild effect (level 1). A wheelchair adaptable foot bathing apparatus (deep type) -E assumes more mildly disabled persons, and adjusts the microbubble devices so as to set the level of the blood flow promotion quantity to a hard effect (level 2).

In consideration of the foregoing, Table 2 shows the number of microbubble generating devices deployed in the delivery foot bathing apparatus for each apparatus, an achieved level, a blood flow promotion target quantity, and properties.

TABLE 2

| APPARATUS | | | BLOOD FLOW | |
|---|---|---|---|---|
| NUMBER/APPARATUS | NUMBER OF | ACHIEVED | PROMOTION | PROPERTIES OF |
| NAME | MB DEVICES | LEVEL | QUANTITY | APPARATUS |
| (NUMBER OF USERS) | (NUMBER) | (LEVEL) | (Qₘ/Q₀) | (MAIN APPLICATION) |
| 4-1 WHEELCHAIR | 6 | LEVEL 1 | 1.5 to 2 | BLOOD FLOW |
| ADAPTABLE FOOT | | | | PROMOTION/IMPROVEMENT |
| BATHING APPARATUS | | | | OF EDEMA, ETC. |
| (NORMAL TYPE)-A | | | | |
| 4-2 WHEELCHAIR | 6 | LEVEL 2 | 2 to 4 | BLOOD FLOW |
| ADAPTABLE FOOT | | | | PROMOTION/IMPROVEMENT |
| BATHING APPARATUS | | | | OF EDEMA, ETC. |
| (NORMAL TYPE)-B | | | | |
| 4-3 WHEELCHAIR | 6 | LEVEL 2 TO 3 | 4 to 5 or more | BLOOD FLOW |
| ADAPTABLE FOOT | | | | PROMOTION/IMPROVEMENT |
| BATHING APPARATUS | | | | OF EDEMA, ETC. |
| (NORMAL TYPE)-C | | | | |
| 4-4 WHEELCHAIR | 6 | LEVEL 1 | 1.5 to 2 | BLOOD FLOW |
| ADAPTABLE FOOT | | | | PROMOTION/IMPROVEMENT |
| BATHING APPARATUS | | | | OF EDEMA, ETC. |
| (DEEP TYPE)-D | | | | |
| 4-5 WHEELCHAIR | 6 | LEVEL 2 | 2 to 4 | BLOOD FLOW |
| ADAPTABLE FOOT | | | | PROMOTION/IMPROVEMENT |
| BATHING APPARATUS | | | | OF EDEMA, ETC. |
| (DEEP TYPE)-E | | | | |

(Qₘ: blood flow under supply of microbubbles, Q₀: blood flow under normal bathing (no microbubble))

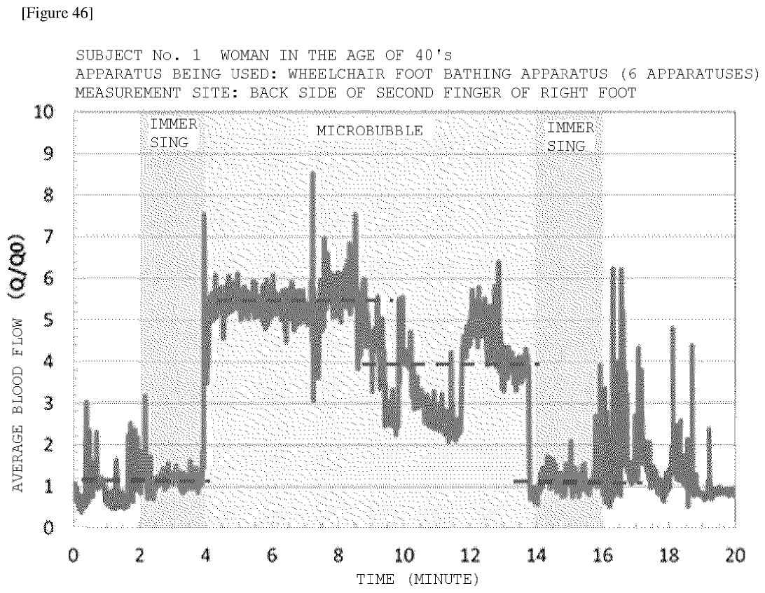

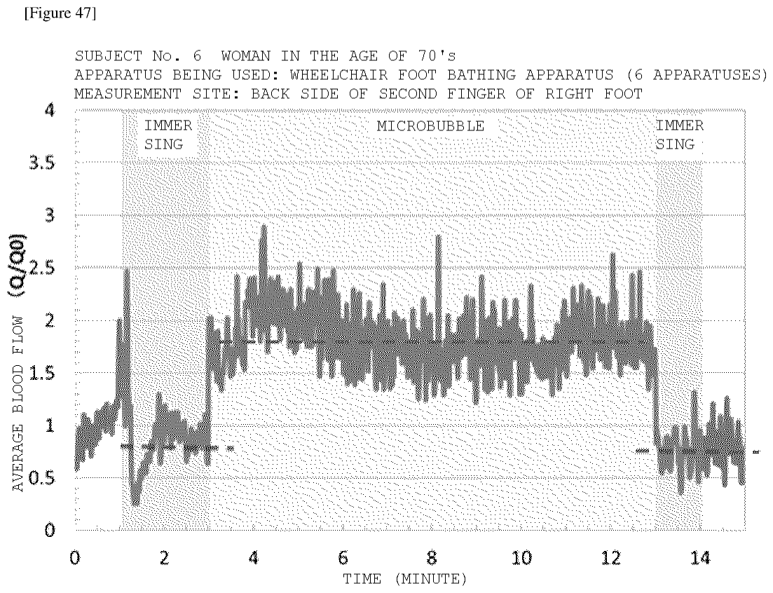

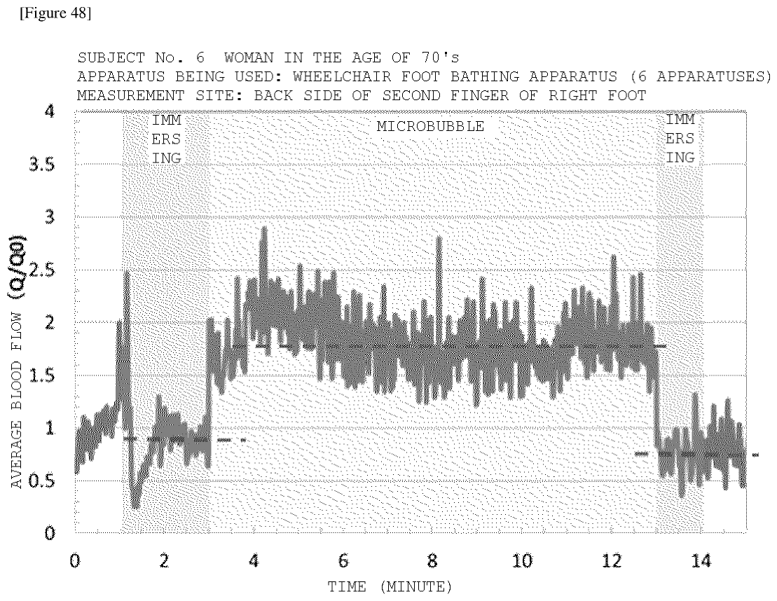

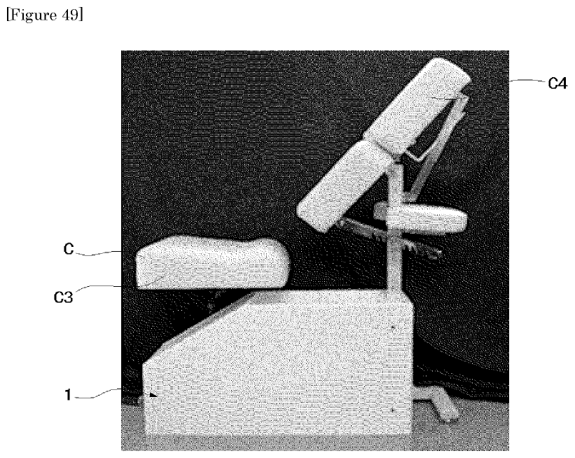

FIGS. 46 to 48 show representative results of a blood flow test performed by using the wheelchair adaptable foot bathing apparatus. The water temperature under the test was about 40° C. The respective results correspond to the above-described levels 3 to 1, respectively. From these results, when the blood flow of a red dotted line shown in each figure is set as a reference, the blood flow promotion quantities by microbubbles indicate 2.5 to 5.8 times, 2 to 3.2 times, and 1.75 to 2.8 times, respectively. The variation of the blood flow quantity caused by generation of microbubbles has a tendency of indicating a substantially constant value after initially increasing rapidly, then gradually decreasing with time lapse, and then settling down to a substantially constant value. This tendency also appears in the results of the three parties.

Furthermore, it is also important that when microbubbles are supplied, the amplitude of the blood flow waveform is larger as compared with that before and after the microbubbles are supplied (this characteristic has already been considered and will be omitted here).

Although illustration is omitted, a swelling and edema improvement experiment of the foot was conducted by using the wheelchair adaptable foot bathing apparatus. A subject is an 84-year-old woman who is difficult to walk smoothly and walks by using a walking support device.

Since this experiment was a first trial, the microbubble supply time in the present care bathing was 12 minutes, and the water temperature was about 40° C. By this comparison, the changes and differences before and after the experiment are clear, and the following notable features are pointed out.

(1) Swelling and edema have been improved together with ankles, and the feet have become slightly thinner. In addition, depressions caused by tightening of socks have been improved, and unevenness has been smoothed.
(2) The swelling and edema of the overall feet have been improved, and the feet have become thinner. Conversely, the toes have been slightly swollen and become larger. This dilation is a phenomenon common to microbubble bathers, and the cause is considered to reside in that blood vessels dilated due to blood flow promotion, and this dilation affected the thickness of the toes. The toes are thinner than the ankles, and it can be said that the variation of the toes is easy to understand.
(3) The color of the skins of the overall feet has changed, the color and gloss of the skin is improved, and looks whitish. This is also a common color change of skins. It is speculated that this may be reflected by an improvement in hyperemia caused by swelling and edema of the feet and by the induction of the blood flow promotion. This is also similar to a phenomenon that the complexion whitens after bathing and the skin becomes brighter by an improvement of the color and gloss of the skin, which are characteristics of microbubble bathers.
(4) It is also noteworthy that when asking about the moods of the subjects during this care bathing, impressions of “feel comfortable” and “wish to keep this state for a long time” have been received many times. Feeling “comfortable” is also a common important phenomenon in microbubble bathers, and it can be said that this phenomenon is a sensory nerve stimulation phenomenon of microbubbles.

Although illustration is omitted, a comparison is also made before and after a microbubble experiment on a 90-year-old woman who can only walk by using a walking support device. When a person becomes elderly and becomes difficult to walk, the person suffers swelling and edema in feet due to stagnation of blood flow and lymph fluid, and pain becomes noticeable at swollen sites, so that improvements thereof are important issues in the field of life rehabilitation.

In this case, the microbubble supply time was set to 15 minutes because the subjects continued to say that they felt comfortable. The improvement of “swelling” and “edema” after the microbubble experiment by this comparison was clear, and showed the following characteristics.

(1) The ankle has become thinner, and the ankle has changed from so-called “barrel-shape” to “neck-shape”.
(2) With respect to the backs of the feet, a right-side portion toward the photograph is easily swollen, and pain occurs there. The swelling of this portion is improved and the swelling is almost eliminated.
(3) Wrinkles have been formed on an under-ankle portion due to swelling and edema, but these wrinkles almost disappear.
(4) The measurement of the circumferential length of the largest portion of the calf before and after the experiment revealed that the length was shortened by 1.5 cm after the experiment, which made experimenters surprised.

As described above, it was a result attracting much attention that such a good result was produced by just one experiment.

Variations in the skin of the foot caused by the wheelchair adaptable foot care bathing were also observed. A comparison between the skins before and after foot bathing of a woman whose age is in the 70's shows that before the experiment, the skin of the foot became dry and the color and gloss of the skin disappeared in the winter. The microbubble supply time was about 10 minutes, and the water temperature was about 40° C. After the experiment, the dry skin is improved, the moisture retaining property is enhanced, and the color and gloss of the skin are clearly improved. Such an improvement is truly desirable for the subject, and this improvement effect has caused the subject to actively perform the present foot bathing.

Since there has been no existing wheelchair adaptable foot bathing apparatus device, it was important to develop the wheelchair adaptable foot bathing apparatus as a creative product. First of all, since it was impossible to realize the foot bathing unless the foot bathing apparatus was placed below the wheelchair, it was a basic design requirement to reduce the width and height of the foot bathing apparatus. Therefore, it became a root plan to arrange microbubble generating devices on the walls of both sides, and thus the arrangement was performed from both the wall surfaces at the bottom portion and the rear portion. Therefore, it was required to implement an idea and a device beyond so-called antinomy that the size of the water tank is miniaturized and also microbubbles are allowed to be proximately and sufficiently jetted to the lower limb portions in the water tank, and this requirement has been realized. This miniaturization of the water tank has rather increased the generation density of microbubbles (the ratio of the water tank volume to the amount of generated microbubbles), and has made it possible to achieve more significant blood flow promotion.

An “expected effect” in the microbubble foot bathing is to i) promote blood flow on the skin surfaces of the entire lower limbs by filling the whole water tank with a high density of microbubbles, and ii) to locally achieve more significant blood flow promotion at affected sites by proximate jetting of microbubbles, thereby realizing the improvement in swelling and edema, relief of pain, and softening of muscles. Particularly, for the latter, positioning for proximate jetting of microbubbles was important, and it was important that microbubbles were enabled to be selectively and intensively jetted to a toe (especially the thumb) portion, a slightly outside portion of the top of the foot (much swelled portion), the ankle, the Achilles tendon etc. to enhance the efficiency of an improvement on the affected sites and the efficiency of an improvement on the lower limbs derived therefrom. Furthermore, these improvements further improved swelling and edema of the feet, stiffened muscles were softened, and the pain in the sites was relieved.

As a result of the sensory nerve stimulation action of microbubbles, the wheelchair adaptable foot bathing has caused all the subjects to say “feel good” and “feel comfortable” and like and positively take the wheelchair adaptable foot bathing. As a result, walking ability has been improved, which has helped to improve life rehabilitation.

By continuously repeating the improvement of skins through the wheelchair adaptable foot bathing, the tinea of the toes has been improved. In addition, cleaning of the feet and the toes has proceeded by microbubble washing, and it has been possible to eliminate residences of Trichophyton, etc. Furthermore, the foot bathing has improved the skins and further enhanced the moisture retaining property.

Staffs of the facilities N have deepened their understanding about microbubbles, and developed the positive application of the microbubbles to persons in need of care. As a result, it has been considered to make this wheelchair adaptable foot bathing apparatus a dominant technique for future life rehabilitation.

### Fourth Example (Example of One-Knee Bathing Microbubble Apparatus and Both-Knees Bathing Microbubble Apparatus)

An apparatus for knee bathing adaptable to a dedicated chair shown in FIG. 49 has been developed. A knee care bathing apparatus (for both legs) in a normal sitting posture makes is possible to jet microbubbles to the vicinities of both knees.

As shown in FIGS. 11 and 12, both the knees were placed in the water tank, and an arrangement was made so that microbubbles could be jetted from each of two microbubble generating devices placed on the front side to the upper and lower sides of each of the knees, and further microbubbles could be also jetted from the rear side of each of the knees to the positions of an upper portion, a center and a lower portion of the knee. As a result, it is noteworthy that it is possible to perform jetting of microbubbles on the front and rear sides of the knees and promote blood flow at the knees.

This apparatus is characterized in that a microbubble generating device water tank and a dedicated tilt chair are used in combination. As a result, the knees can be infiltrated in the water tank without difficulty, and it is possible to relieve pain, swelling and the like of a knee portion by supplying a large amount of microbubbles to the knee portion and the periphery thereof.

There has been no effective apparatus for intensively jetting microbubbles to the knee portion to improve the knee portion, and the originality and usefulness of the present technique resides in trying to newly develop an effective apparatus. Furthermore, it is also an important feature that the jetting positions of microbubbles are effectively set to the knee portion and the front and rear sites of the knee portion to cause blood flow promotion at not only the knee portion, but also over a wide range of the peripheral portion of the knee portion. Furthermore, it is also important that by dedicating the apparatus to the right leg, the water tank can be miniaturized, and microbubbles can be generated at high concentration with respect to the amount of water.

Table 3 shows the number of microbubble generating devices deployed in the knee bathing microbubble apparatus for each apparatus, an achieved level, a blood flow promotion target quantity, and properties.

TABLE 3

| APPARATUS | | | BLOOD FLOW | |
|---|---|---|---|---|
| NUMBER/APPARATUS | NUMBER OF | ACHIEVED | PROMOTION | |
| NAME | MB DEVICES | LEVEL | QUANTITY | PROPERTIES OF APPARATUS |
| (NUMBER OF USERS) | (NUMBER) | (LEVEL) | (Qₘ/Q₀) | (MAIN APPLICATION) |
| 3-1 KNEE BATHING | 6 | LEVEL 1 TO 2 | 1.5 to 3 | BLOOD FLOW |
| MICROBUBBLE | | | | PROMOTION/WASHING/RELIEF |
| APPARATUS (FOR RIGHT | | | | OF PAIN, ETC. |
| LEG) | | | | |
| 3-2 KNEE BATHING | 6 | LEVEL 1 TO 2 | 1.5 to 3 | BLOOD FLOW |
| MICROBUBBLE | | | | PROMOTION/WASHING/RELIEF |
| APPARATUS (FOR LEFT | | | | OF PAIN, ETC. |
| LEG) | | | | |
| 3-3 KNEE BATHING | 12 | LEVEL 1 TO 2 | 1.5 to 3 | BLOOD FLOW |
| MICROBUBBLE | | | | PROMOTION/WASHING/RELIEF |
| APPARATUS (FOR BOTH | | | | OF PAIN, ETC. |
| LEGS) | | | | |

(Qₘ: blood flow under supply of microbubbles, Q₀: blood flow under normal bathing (no microbubble))

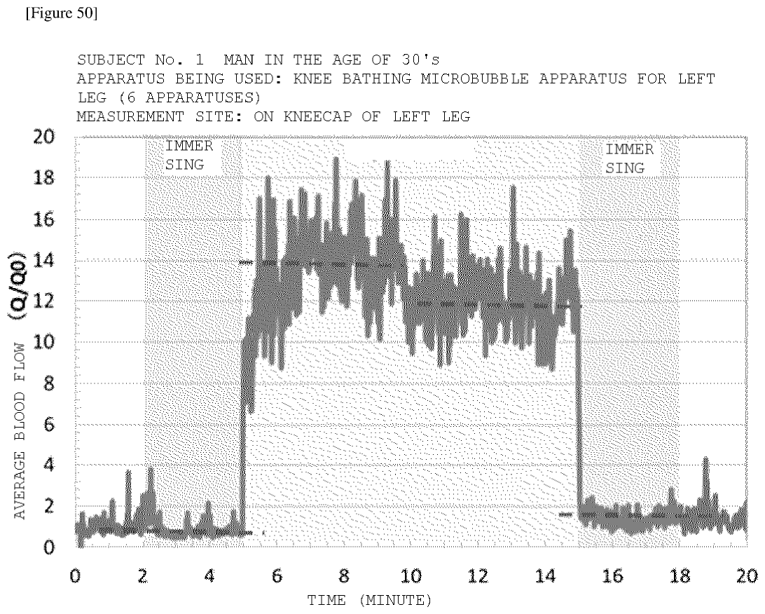

FIG. 50 shows an example of a result of a blood flow measurement experiment using the knee bathing microbubble apparatus (for the left leg). The subject is a 31-year-old man. The water was tap water and the temperature of the water was 40° C. The blood flow sensor was placed on the patella. Even when the leg was infiltrated with hot water, the variation of blood flow hardly occurred, but when microbubbles were generated under this state, the blood flow promotion quantity reached about 10 to 18 times. When a time zone for supply of microbubbles is divided into former and latter halves, the value of the blood flow promotion quantity is a little high in the first half, and slightly decreases in the latter half, which indicates the most general variation tendency. After microbubbling is stopped, the blood flow rapidly decreases, but the value thereof is higher by about 2 to 3 times as compared with that before supply of microbubbles (see a dotted line portion), which indicates the residual effect of supply of microbubbles.

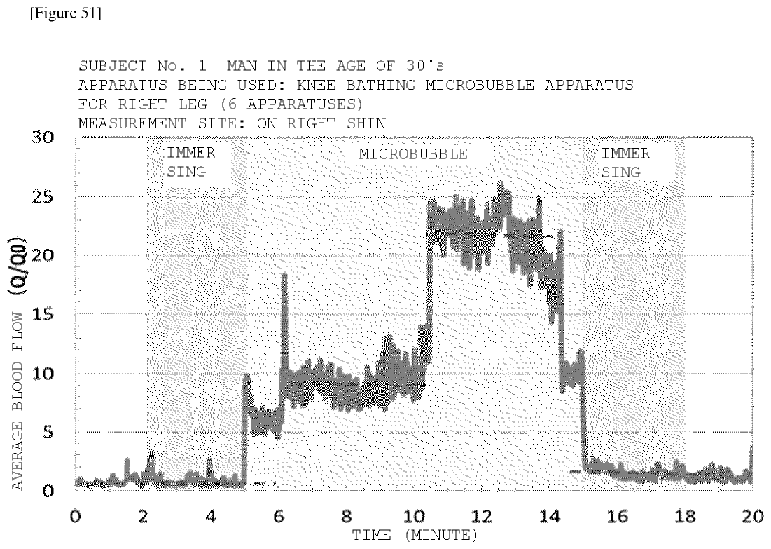

FIG. 51 shows an example of a result of a blood flow measurement experiment using a knee bathing microbubble apparatus (for the right leg). The subject is a 31-year-old man. The water was tap water and the temperature of the water was 40° C. The blood flow sensor was placed on the patella. Even when the leg was infiltrated in hot water, the variation of the blood flow hardly occurred, but when microbubbles were generated in this state, the blood flow promotion quantity reached about 8 to 14 times. However, at the time point after 14 minutes had elapsed, the blood flow started to increase again and reached about 20 to 25 times and became a constant value. Presumably, it is estimated that the cause of this rapid increase may be a phenomenon occurring because of approach of a sensor mount portion to the jetting position of microbubbles.

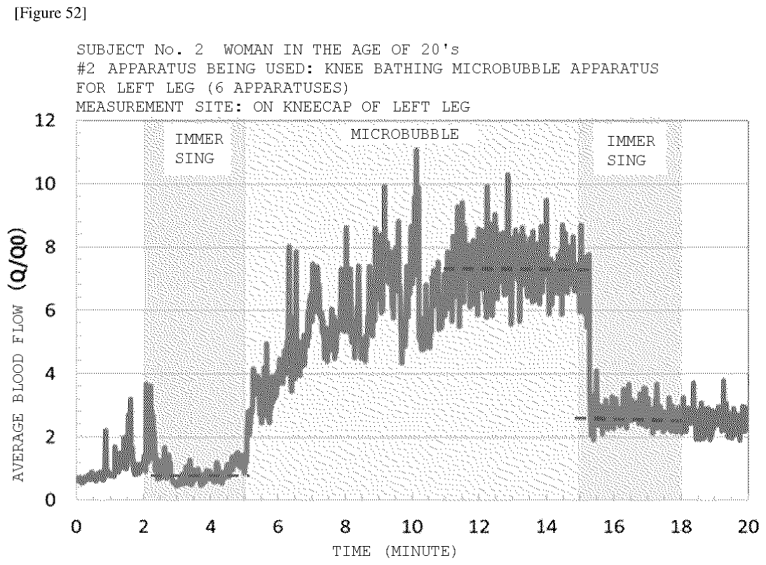

FIG. 52 shows an example of a result of a blood flow measurement experiment using the knee bathing microbubble apparatus (for the left foot). The subject is a 28-year-old woman. The water was tap water and the temperature of the water was 40° C. The blood flow sensor was placed on the patella. The other matters are identical to those under the experimental condition shown in FIG. 50.

Even when the leg was infiltrated in hot water, the variation of the blood flow hardly occurred, but when microbubbles were generated in this state, the blood flow starts to increase gradually, and reaches about 7.5 times after 10 minutes has elapsed. After microbubbling is stopped, the blood flow is higher by about three times than that before supply of microbubbles (see a dotted line portion), and the residual effect of supply of microbubbles appears well.

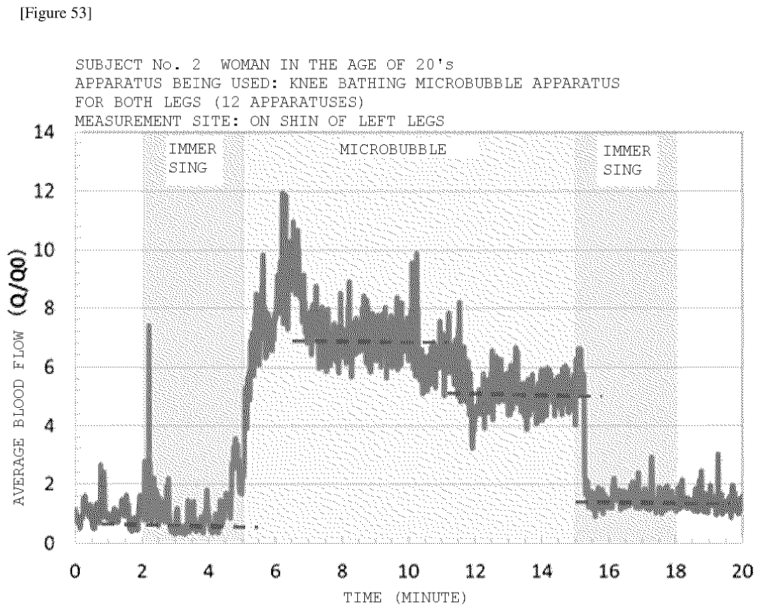

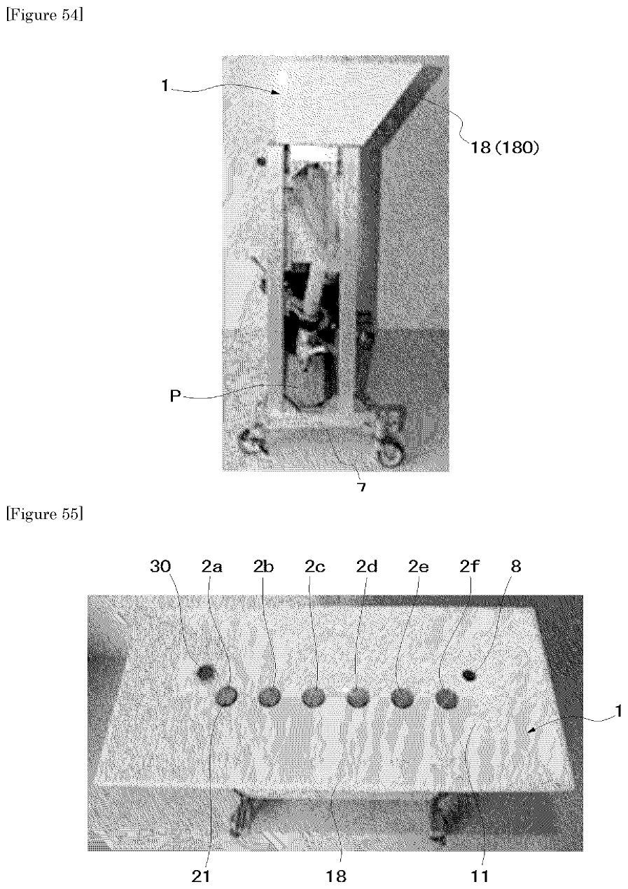

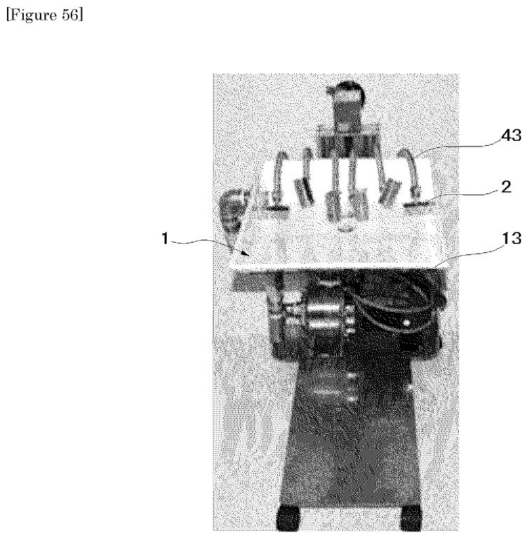

FIG. 53 shows an example of a result of a blood flow measurement experiment using a knee bathing microbubble apparatus (for both legs). The subject is a 28-year-old woman. The water was tap water and the temperature of the water was 40° C. The blood flow sensor was placed on the patella of the left leg. The other matters are the same as those under the experimental condition shown in FIG. 39.

Even when the legs were infiltrated with hot water, the variation of the blood flow hardly occurred, but when microbubbles were generated in this state, the blood flow increases rapidly and the blood flow promotion quantity reaches about 13 times (a dotted line portion before supply of microbubbles is set as a basic blood flow). Thereafter, the blood flow gradually decreases and indicates about 8 times and 6 times (see dotted lines). After microbubbling is stopped, the blood flow is higher by about twice than that before supply of microbubbles (see the dotted lines), and the residual effect of supply of microbubbles appears well.

As described above, a significant blood flow promotion effect by microbubbles was also confirmed in this knee bathing apparatus.

It has been very important to develop a knee bathing microbubble apparatus as a creative product because there has been no existing knee bathing apparatus using a microbubble technology. First, it had been variously examined how to maintain a comfortable posture with neither stress nor fatigue when performing the knee bathing, but a state where no good idea had been provided had continued. Thereafter, it was introduced from the facilities N that there was an optimal chair, and earnest development of the present apparatus has been advanced. This development has provided a knee bathing apparatus for one leg of the right and left legs. It has been an important development point that the position of the knee can be lowered by adopting the chair and it is possible to perform proximate jetting of microbubbles on the assumption that the position of the knee can be lowered by adopting the chair.

As a result, it has been possible to perform proximate jetting of microbubbles, and blood flow promotion by microbubbles which has greatly exceeded an original target value has been achieved by adding an effect of reducing the volume of the water tank because of a design for one leg. Furthermore, the present knee bathing apparatus not only has achieved proximate jetting of microbubbles around the knee portion, but also has jetted lots of microbubbles to a leg portion of the front and rear portion of the knee, so that the peripheral portion of the knee has been greatly improved by the blood flow promotion effect. As a result, it is important that the present apparatus is not limited to an apparatus for only an improvement by knee bathing, but has become an apparatus capable of affecting the entire leg centered on the knee.

Persons who experienced this knee bathing said, in a breath, i) “I feel good”, ii) “I wish to keep bathing for a long time”, iii) “I may do some head work in combination with this knee bathing. Rather, it may cause my brain activation”, iv) “hot water does not cool forever, but conversely becomes hot”, v) “after bathing, I felt my leg light for about a day with warm feeling”, and vi) “I felt as if I had taken a bath and did no longer want to take a bath”, etc., and very wonderful impressions have been received. These are important speeches suggesting that a very important research issue exists.

### Fifth Example (Example of Upper Limb Care Bathing Apparatus)

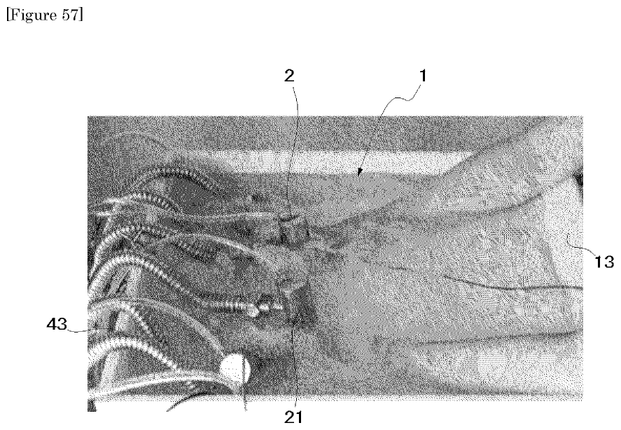

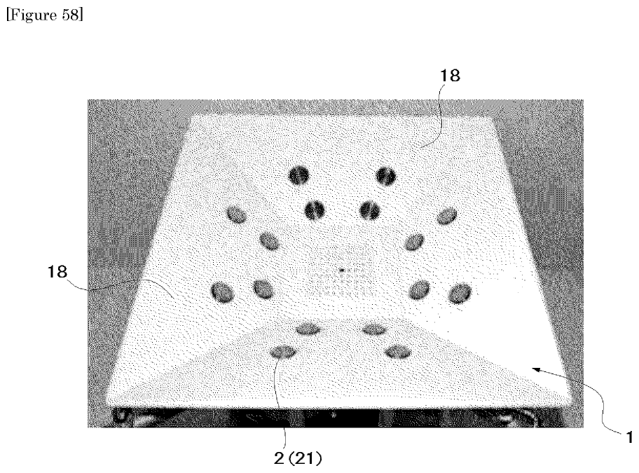

FIGS. 54 and 55 show an “upper limb care bathing apparatus (for one person) -A”. As is apparent from these figures, the subject can perform care bathing while putting the upper limb in the water tank while sitting on a wheelchair. At that time, the microbubble generating device is arranged at the bottom portion, and microbubbles are jetted proximately to the upper limb in a blow-down state. At that time, the front side of the water tank has a sloped side wall, which makes it easy to insert the upper limb. A pump, etc. are compactly accommodated in the lower portion of the water tank, and arranged on a movable carriage. This makes it easy to freely move the apparatus, so that the apparatus can be used in a living room or an open space.

Furthermore, the arrangement of the microbubble generating devices in the water tank is considered, and with respect to fingers, palms and arms, angles thereof with respect to microbubbles and microbubble water jetted from the lower side are changed to some extent so that the microbubbles can be hit to problematic affected sites.

Furthermore, a fatigue of a subject when the subject places an arm in the apparatus and a problem caused by keeping the posture are considered, and attention is paid so that it is possible to use the apparatus in a non-stressed comfortable posture. Particularly, with respect to this problem, it has been noted that during the test, microbubble jetting applies buoyance to the arm in the water to slightly float the arm, and the microbubble jetting generates reaction force against the gravity of the arm, so that a state of floating the arm in the water can be created, and thus it is possible to leave the arm above the water stream.

Next, FIGS. 56 and 57 show an “upper limb care bathing for both hands (for one person) -B”. This was also devised so that it could be used while a wheelchair was used. The water tank was set at the upper portion, and the height of the water tank was made variable, so that the height could be adjusted according to the body size of a person in need of care. The microbubble generating device adopted proximate jetting from the upper side, and was enabled to perform the proximate jetting from the upper portion, diagonally from the upper portion, and from the side, respectively. This makes it possible to proximately jet microbubbles to the fingers and palms of both hands, and the front and back portions of the wrist.

In addition, the pump, etc. were collectively and compactly mounted on the back side of the lower portion of the water tank so that they would not be obstacles when the apparatus was used by the person in need of care. Furthermore, for the person in need of care, when there is a problematic affected site at the upper limb, the direction and position of the microbubble jetting can be subtly moved (since the flexible tube is used, the adjustment is possible).

FIG. 58 shows an “upper limb care bathing (for 4 persons)”. Piping parts such as a pump and a liquid header are provided below the water tank on the upper side, and they are compactly mounted on a movable carriage of the lowermost portion.

The microbubble generating device is arranged at the lower portion of the water tank in a blow-down state. A total of 16 devices are installed for four persons, every four devices being used for one person. In the design of this water tank, various shapes were considered for the water tank, and a round shape, a hexagonal shape, etc. were considered, and a square was finally selected. With respect to the sloped wall of the water tank, the optimum angle of the sloped wall was considered, and the result was reflected so that the person in need of care could easily use it. With respect to drainage and suction, they are performed at the center portion of the water tank, and by covering a suction port with a lid to make the suction port invisible directly, a risk that the hand is sucked into the suction port is eliminated. The material was white acrylic resin, and cleanliness and ease of washing were considered.

For the determination of the size of the water tank, it was considered that even when four persons were close to one another, they did not feel cramped, and they were not too far away.

The foregoing is summarized, and Table 4 shows the number of microbubble generating devices deployed in the upper limbs care bathing apparatus for each apparatus, an achieved level, blood flow promotion target quantity, and properties.

TABLE 4

| | | | BLOOD FLOW | |
|---|---|---|---|---|
| APPARATUS | NUMBER OF | ACHIEVED | PROMOTION | |
| NUMBER/APPARATUS NAME | MB DEVICES | LEVEL | QUANTITY | PROPERTIES OF APPARATUS |
| (NUMBER OF USERS) | (NUMBER) | (LEVEL) | (Qₘ/Q₀) | (MAIN APPLICATION) |
| 6-1 UPPER LIMB CARE | 6 | LEVEL 2 | 2 to 4 | BLOOD FLOW |
| BATHING APPARATUS (FOR | | | | PROMOTION/WASHING/RELIEF |
| ONE PERSON)-A | | | | OF PAIN, ETC. |
| 6-2 UPPER LIMB CARE | 8 | LEVEL 2 | 2 to 4 | BLOOD FLOW |
| BATHING APPARATUS (FOR | | | | PROMOTION/WASHING/RELIEF |
| ONE PERSON)-B | | | | OF PAIN, ETC. |
| 6-3 UPPER LIMB CARE | 16 | LEVEL 1 | 1.5 to 2 | BLOOD FLOW |
| BATHING APPARATUS (FOR | | | | PROMOTION/WASHING/RELIEF |
| FOUR PERSONS) | | | | OF PAIN, ETC. |

(Qₘ: blood flow under supply of microbubbles, Q₀: blood flow under normal bathing (no microbubble))

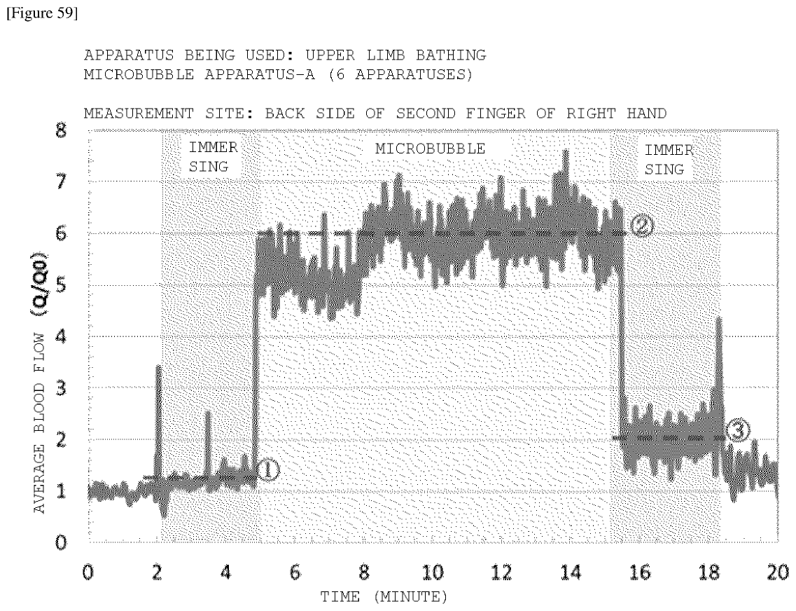

FIG. 59 shows a representative result of a blood flow test performed by using the “upper limb care bathing apparatus (for one person) -A”. The subject is a woman in the age of 20's. The water under the test was tap water, and the temperature of the water was about 40° C. This test corresponds to the level 2 described above.

Along with occurrence of microbubbles, rapid blood flow promotion by the microbubbles occurred. When a blood flow of a red dotted line (1) shown in the figure is set as a reference, the respective blood flow promotion quantities by microbubbles indicate 3.5 to 5.7 times, which exceed an initial target value. In addition, comparing the blood flow after stopping microbubbling with that before generation of microbubbles is started, the blood flow quantity is 1.5 times, which indicates a considerable residual effect.

When this blood flow experiment was performed, the arm was floated by jetting of microbubbles from the bottom, and impressions of feeling the arms light and feeling comfortable were stated.

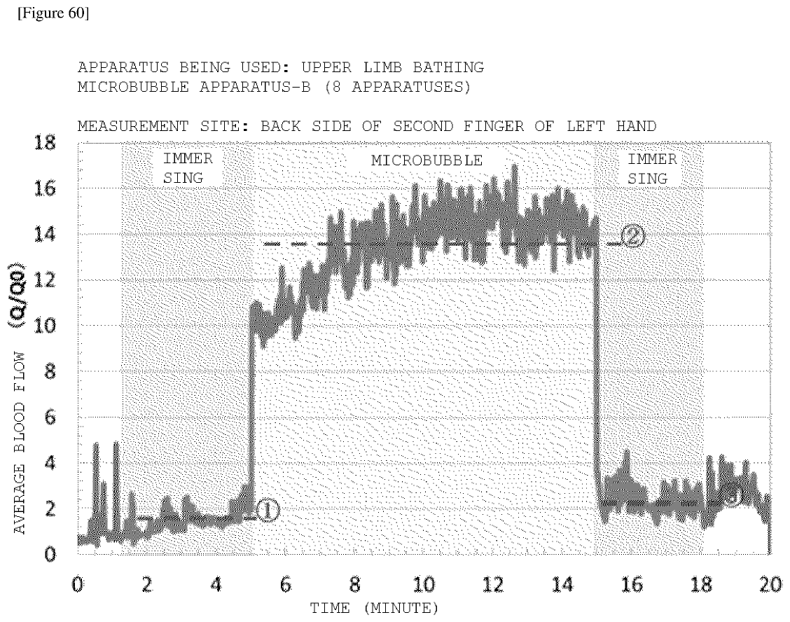

FIG. 60 shows a representative result of a blood flow test performed by using the “upper limb care bathing apparatus (for one person) -B”. The subject is a woman in the age of 30's. The water under the test was tap water, and the temperature of the water was about 40° C. This test corresponds to the level 2 described above.

Along with occurrence of microbubbles, rapid blood flow promotion by the microbubbles occurred. When a blood flow of a red dotted line (1) shown in the figure is set as a reference, the blood flow rapidly increases up to 5.5 times of the above blood flow, and then gradually increases and reaches 8.9 times at maximum. When the blood flow after stop of microbubbling is compared with that before generation of microbubbles starts, the value is 1.4 times, which indicates the residual effect of microbubbles.

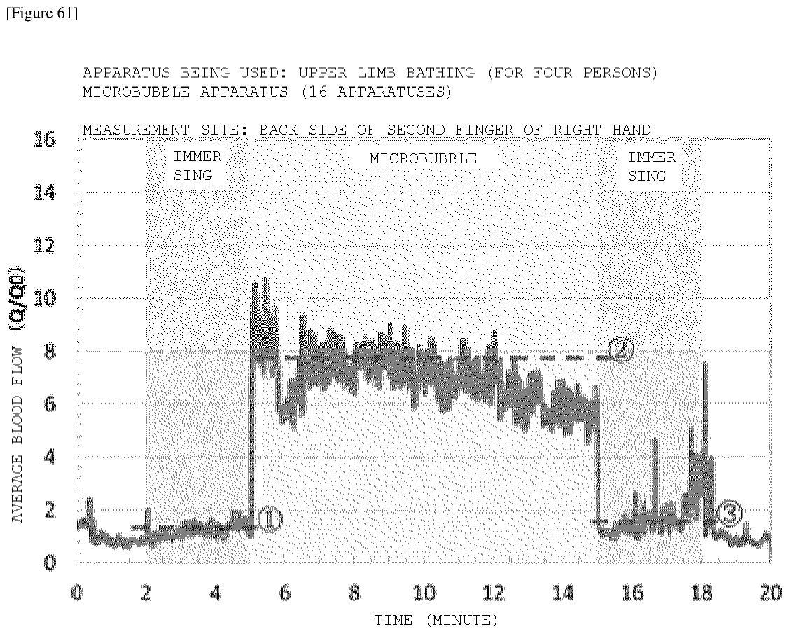

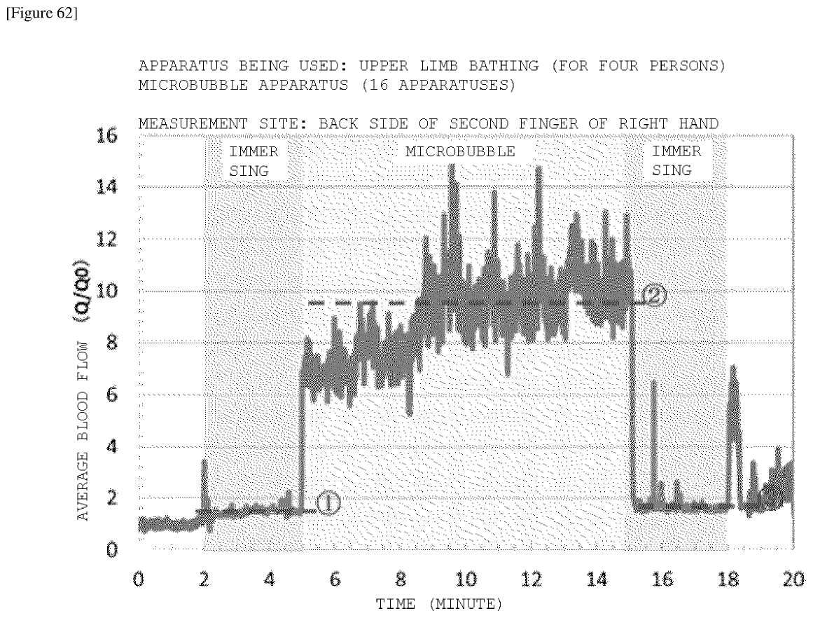

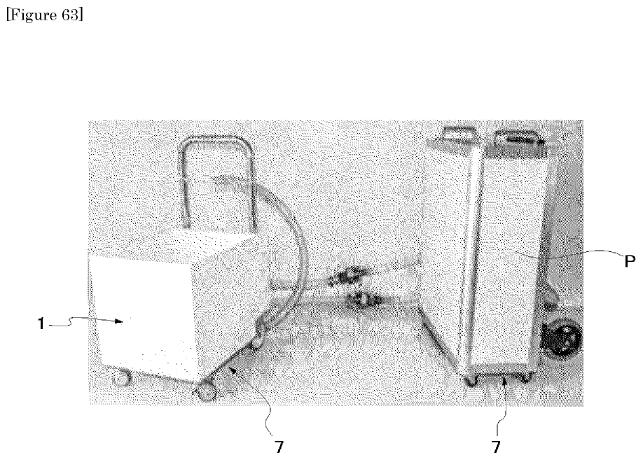

FIGS. 61 and 62 show representative results of blood flow tests performed by using the “upper limb care bathing apparatus (for 4 persons)”. The subject in the former is a woman in the age of 30's, and the subject in the latter is a woman in the age of 20's. The water under the tests was tap water, and the temperature of the water was about 40° C. These tests correspond to the level 2 described above.

As a result, in the former, the blood flow increases rapidly along with occurrence of microbubbles, and reaches up to 5.6 times. Thereafter, the blood flow gradually decreases to about 3.8 times. In the latter, the blood flow rapidly increases to about 4.1 times immediately after occurrence of microbubbles, and then gradually increases up to about 6 times. In addition, in these experiments, a slight residual effect is apparent even after microbubbling stops (as apparent from the difference between the levels of the red dotted lines (1) and (3)).

Although illustration is omitted, an example of a comparative result before and after a hand bathing experiment performed by using the present apparatus is shown. The state of the hand is clearly changed before and after the microbubble experiment. A first change resides in that the hand of a subject to which microbubbles are applied looks plump and beautiful. When the ages of both the hands are guessed, it seems that the hand after the experiment clearly looks like younger hand.

A second change resides in that after the microbubble experiment, the thickness of the fingers is different, and the fingers after the microbubble experiment clearly looks larger. Many cases where the fingers have become thicker as described above have been observed, and this result is in line with that tendency.

A third change resides in that the color of the skin is different, and the skin after microbubbles are supplied looks slightly whitish as compared to that before the experiment for an unknown reason. This tendency is also very similar to the previous results. However, the cause of whitening of the skin is unknown.

Two types of upper limb care bathing apparatuses for one person and one type of upper limb care bathing apparatus for four persons were developed by using the microbubble technology, and blood flow promotion experiments were conducted. As a result, in any of the apparatuses, significant blood flow promotion by microbubbles were realized, and a success over an initial target could be achieved. From now on, it is important to investigate the mechanism of the action and conduct quantitative evaluation by increasing the number of subjects.

Another important feature exhibited by these upper limb care bathing apparatuses resides in that the action of sensory nerve stimulation by microbubbles extends to the brain and the subjects all together emphasize “feeling comfortable” of bathing. Since this strongly suggests that microbubbles are effective to not only softening of muscles and remedy of swelling and edema, but also remedy of a nervous system, it is important to have a future deep investigation for establishment of life rehabilitation from this viewpoint.

More specifically, the following remarkable phenomena and advantages were confirmed.

(1) With respect to the “upper limb care bathing apparatus (for one person)-A”, there was found a phenomenon that microbubbling from the bottom portion exerted force for slightly floating the entire arm in water, and the subjects felt their hands lighter. As a result, a bathing method in which the subjects leave their hands in microbubble bathing with more relaxation was established. In addition, this bathing also made it possible to eliminate “discomfort” caused by persistent fatigue of the hand, and as a result, recovery from fatigue was sustained, and conversely, a prevention effect of suppressing fatigue was recognized. It was also confirmed that the foregoing remedy was also applied with respect to pain of the hand, and it was also confirmed that when microbubbles were jetted to a site of the hand, the pain was relieved more than expected in a short period of time.
(2) With respect to the “upper limb care bathing apparatus (for one person)-B”, since a large amount of microbubbles were three-dimensionally and proximately jetted from an upper side, an obliquely upper side and a side to sites such as fingers and the vicinity of the wrist, and the palm and the back of the hand, it was possible to supply microbubbles while wrapping these sites from the three sides and filling the microbubbles. As a result, the subjects were enabled to receive proximate jetting of microbubbles in favorite directions and at favorite positions, and also the subject could confirm the effect while looking at the effect in front of them, which brought a very good synergistic effect.
(3) As a result of a hand bathing experiment using the “upper limb care bathing apparatus (for four persons)”, important changes such as 1) the hand became beautiful, 2) the fingers swelled, and 3) the skin became slightly white were observed.
(4) With respect to the “upper limb care bathing apparatus (for four persons)”, it can be simultaneously used by one to four persons, and face-to-face conversation and exchange at that time have brought about a very important effect. As described above, there have been no other cases where a pleasant care bathing is performed, and educational effects such as experiential information exchange and learning exchange are excellent, and it is important to advance the investigation in cooperation with the facilities N so as to enable quantitatively evaluation on the foregoing matters.

As described above, the important effectiveness of the upper limb care bathing apparatus was confirmed. In the future, it is important to investigate the problems indicated in the foregoing ii) to iii) more deeply.

### Sixth Example (Example of Delivery Foot Bathing Device)

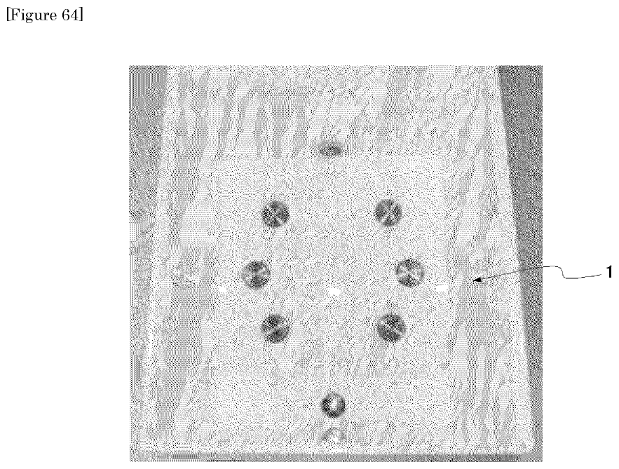

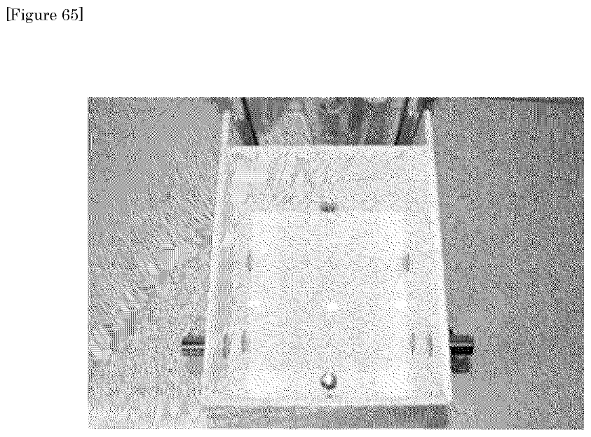

FIG. 63 shows an entire apparatus system of the delivery foot bathing apparatus-A and a state where a water tank portion of the apparatus and a pump are connected to each other via a hose. FIG. 64 is a plan view of the water tank. From these figures, three sites of the underside of a foot such as a toe portion, a central portion (pressure point name is “Yusen”), and a portion which is slightly nearer to the finger side than a heel portion, which are places where pain is likely to occur, are selected to enable stimulation on the underside of the foot by proximate jetting microbubbles.

Next, the “delivery foot bathing apparatus-B” shown in FIG. 65 uses six microbubble generating devices, which are respectively mounted at three places on each of both the side wall surfaces of the water tank. The blowout of the microbubbles is performed horizontally from the side walls to the center of the water tank, which correspond to the top of the feet, the ankle portions of the feet and the side portions of the calves, and it is possible to promote significant blood circulation by the proximate jetting of microbubbles while the above sites are centered. The microbubble generating devices are arranged so that the jetting of microbubbles is performed from the side surface walls on both the sides, and is intensively performed on three sites of a lowermost portion which is a toe portion (the pressure point name is “Yinpaku”), a middle portion which is a lower portion of the ankle (the pressure point name is “Konron”, a place where pain occurs), and an upper portion which is in the vicinity of a side portion of the calf (the pressure point name is “a portion extending from Horyu to Sanri”). When a foot has a disorder, these sites are portions that cause stiffness and pain, and it is noted that it is possible to perform stimulation of the side surface of the foot by microbubbling centered on these foot pressure points.

In consideration of the foregoing, Table 5 shows the number of microbubble generating devices deployed in the delivery foot care bathing apparatus for each apparatus, an achieved level, blood flow promotion target quantity, and properties.

TABLE 5

| | | | BLOOD FLOW | |
|---|---|---|---|---|
| APPARATUS | NUMBER OF | ACHIEVED | PROMOTION | |
| NUMBER/APPARATUS NAME | MB DEVICES | LEVEL | QUANTITY | PROPERTIES OF APPARATUS |
| (NUMBER OF USERS) | (NUMBER) | (LEVEL) | (Qₘ/Q₀) | (MAIN APPLICATION) |
| 7-1 DELIVERY FOOT CARE | 6 | LEVEL 1 to 2 | 1.5 to 3 | BLOOD FLOW |
| BATHING APPARATUS-A | | | | PROMOTION/WASHING/RELIEF |
| | | | | OF PAIN, ETC. |
| 7-2 DELIVERY FOOT CARE | 6 | LEVEL 1 to 2 | 1.5 to 3 | BLOOD FLOW |
| BATHING APPARATUS-B | | | | PROMOTION/WASHING/RELIEF |
| | | | | OF PAIN, ETC. |

(Qₘ: blood flow under supply of microbubbles, Q₀: blood flow under normal bathing (no microbubble))

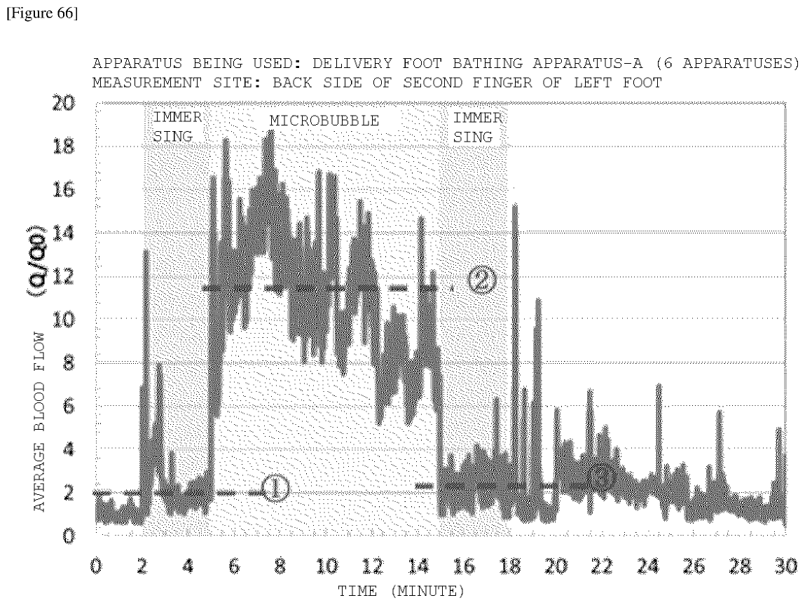

FIG. 66 shows a representative result of a blood flow test performed by using the “delivery foot bathing apparatus-A”. The subject is a woman in the age of 40's. The water under the test was tap water, and the temperature of the water was about 40° C. This test corresponds to the level 2 described above.

As a result, along with occurrence of microbubbles, rapid blood flow promotion by microbubbles occurs, and when the blood flow of a red dotted line (1) shown in the figure is set as a reference, the blood flow promotion quantity by microbubbles is about 9 times at maximum. Thereafter, the blood flow quantity gradually decreases to about four times. By averaging increase and decrease values, a blood flow promotion quantity of about 5.6 times is obtained. This greatly exceeds an initial target value which is 1.5 to 3 times. In addition, when the blood flow quantity after microbubbling is stopped is compared with that before generation of microbubbles is started, it is slightly increased, and a slight residual effect is shown.

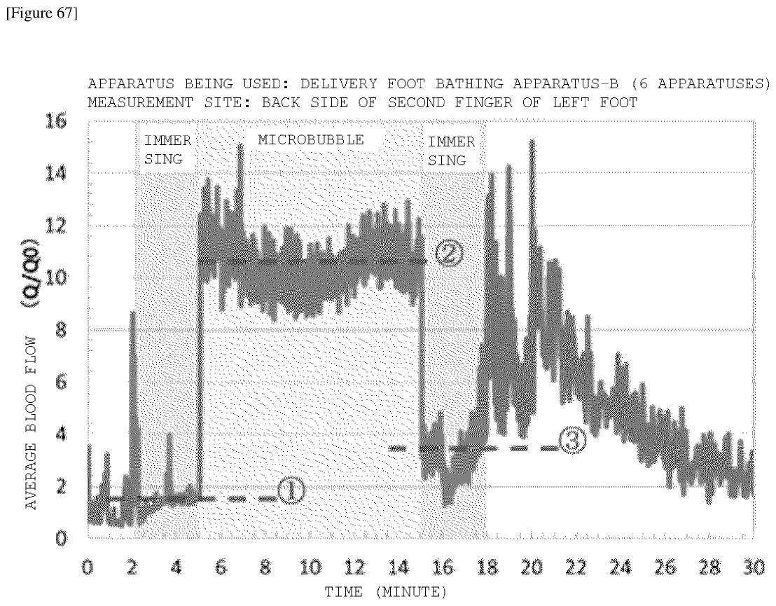

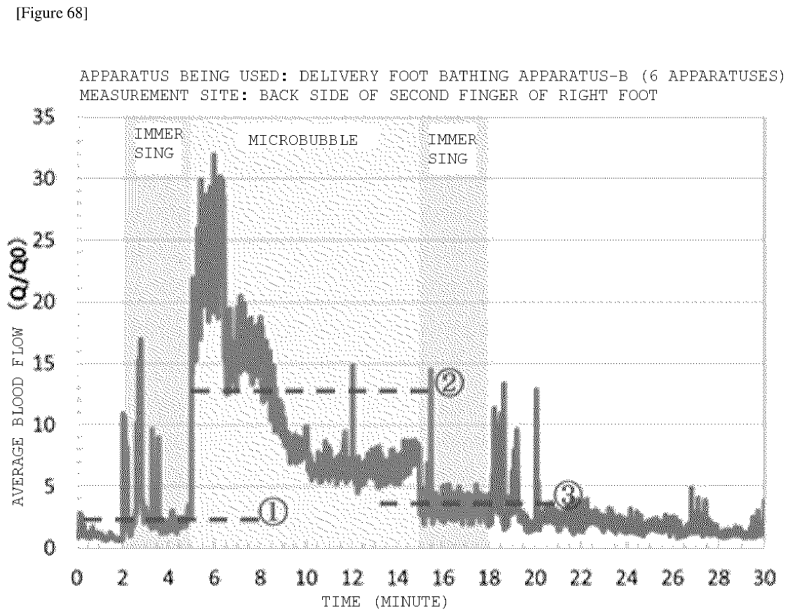

FIGS. 67 and 68 show a representative result of a blood flow test performed by using “the delivery foot bathing apparatus-B”. The subjects are women in their 30's and 60's. The water under the test was tap water, and the temperature was about 40° C. This test corresponds to the level 2 described above.

In the former, rapid blood flow promotion by microbubbles occurs along with generation of microbubbles, and when a blood flow of a red dotted line (1) shown in the figure is set as a reference, the value of about 6 times is indicated. This greatly exceeds an initial target value of 1.5 to 3 times. In addition, when the blood flow after microbubbling is stopped is compared with that before generation of microbubbles starts, the blood flow promotion of about 2.3 times is maintained after the experiment, and the residual effect of microbubbles is shown.

In the latter case, the blood flow promotion by microbubbles also indicates about 5.2 times. In the comparison before and after microbubbling stops, the blood flow of about 1.4 times is maintained.

Two types of the “delivery foot bathing apparatus-A” and the “delivery foot bathing apparatus-B” were developed by using the microbubble technology, and a blood flow promotion experiment was conducted. As a result, in any of the apparatuses, significant blood flow promotion by microbubbles was realized, and the blood flow promotion exceeded an initial target.

The following three points were devised in the development of these apparatuses.

(1) The water tank was miniaturized, and at the same time the microbubble generating device was externally fitted to the side wall (apparatus-A) and the bottom wall (apparatus-B), and significant blood flow promotion was realized by generation of lots of microbubbles.
(2) The pump portion which was most weighty in the whole apparatus was separated, and the water tank portion and the pump portion were placed on separate carriages so that they were allowed to be simultaneously transported independently.
(3) In the arrangement of the microbubble generating devices, the positioning was performed in consideration of pressure points of feet and the undersides of feet and portions with much pain.

Particularly, the stimulation on the undersides of the feet in the “apparatus-B” was strong, and impressions indicating “the feet feel numb” and “feel a tingle” were obtained. On the other hand, an impression indicating that the “apparatus-A” provided a milder and gentler stimulus was also obtained. It is important to create a menu for delivery care bathing according to the difference in these actions and effects and make a choice according to wishes of persons in need of care.

In a test working of these apparatuses, excellent transportability and operability of the apparatuses were confirmed. In addition, it is important that evaluations that were not small were received from everyone in the facilities N.

### DESCRIPTION OF REFERENCE SIGNS

| | | | |
|---|---|---|---|
| 1 | water tank | 1A | water tank main body |
| 1B | front chamber | 1C | rear chamber |
| 1D | bottom chamber | | |
| 10 | bathtub | 11 | bottom surface |
| 12 | front surface | 13 | rear surface |
| 18 | side surface (sidewall surface) | | |
| 130 180 | sloped surface | | |
| 14 | front portion | 15 | bottom portion |
| 16 | side portion | 17 | rear portion |
| 2 | 2A to 2D 2a to 2f MB device | | |
| 20 | gas introduction hole | | |
| 21 | opening portion | 22 | cylindrical space |
| 23 | container main body | 24 | pressurized liquid |
| | | | introduction port |
| 25 | opening | 26 | separate container |
| 27 | through hole | 28 29 | separate container |
| 290 | cap front surface | 291 | center portion |
| 292 | peripheral portion | 293 | in-cap |
| 295 | outside hole | 296 | inside hole |
| 3 | water suction pipe | 30 | suction port |
| 4 | discharge pipe | 40 | pipe |
| 41 | branch pipe | 42 | branch port |
| 43 | flexible tube | | |
| 5 | air header | 50 | socket |
| 6 | connecting portion | 60 | handle |
| 7 | movable carriage | | |
| 8 | drainage port | | |
| 9 | drain port | | |
| P | pump | | |
| C | wheelchair chair | | |
| T | jetting target | | |
| L | lift | | |

1. A health promoting apparatus for promoting health of a jetting target object, comprising:
a microbubble generating device that includes a container main body having a cylindrical space having a gas introduction hole formed on one end side thereof and an opening portion formed on the other side thereof, and a pressurized liquid introduction port opened in a tangential direction thereof at a part of a peripheral surface of an inner wall of the cylindrical space and connected to a pipe for feeding pressurized liquid; and
a water tank for accommodating a jetting target to be exposed to microbubbles jetted by the microbubble generating device and liquid containing the microbubbles, wherein a plurality of microbubble generating apparatuses connected to branch pipes branched from the pipe are arranged so as to be opposite to the jetting target, and the opening portions are arranged in the water tank so as to face the jetting target.

2. A health promoting apparatus, wherein the microbubble generating device has a negative potential of about minus 40 millivolts in liquid, and generates lots of microbubbles each having a diameter of about 10 to 40 μm, most of the microbubbles contracting from just after the generation thereof.

3. The health promoting apparatus according to claim 1, wherein a cap through which microbubbles jetted from the opening portion are jetted like a shower is freely detachably attached on the other side of the microbubble generating device.

4. The health promoting apparatus according to claim 1, wherein the opening portions are arranged such that microbubbles can be proximately jetted to the jetting target.

5. The health promoting apparatus according to claim 1, wherein the water tank is a bathtub, the jetting target object to be accommodated in the bathtub is a jetting target person who bathes while sitting on a seat portion of a chair or a jetting target person who bathes in a lying posture, and the microbubble generating devices are arranged on a bottom surface and a side wall surface of the bathtub.

6. The health promoting apparatus according to claim 1, wherein the jetting target to be accommodated in the water tank is legs of the jetting target person, and the opening portion is arranged so as to be opposite to legs and so as to face right and left insides of both the legs.

7. The health promoting apparatus according to claim 6, wherein a connecting portion for connecting to an adjacent water tank is provided at a front portion of the water tank, and connecting portions of adjacent water tanks are connected to each other by a handle to provide a foot bathing microbubble apparatus for at least two persons.

8. The heath promoting apparatus according to claim 1, wherein the jetting target to be accommodated in the water tank is feet of a jetting target person sitting on a wheelchair, and the water tank is configured to have a shape which enables insertion of the water tank into a space under a seat surface of the wheelchair, and the opening portions are arranged on a bottom surface of the water tank so as to face undersides of both the feet, and are arranged on a rear surface of the water tank so as to face Achilles tendons of both the feet.

9. The health promoting apparatus according to claim 1, wherein the jetting target accommodated in the water tank is one knee of a jetting target person, and the opening portions are arranged on a bottom surface and a front surface of the water tank.

10. The health promoting apparatus according to claim 1 wherein the jetting target to be accommodated in the water tank is both knees of a jetting target person, and the opening portions are arranged on a rear surface of the water tank, enable proximate jetting of microbubbles via a flexible pipe, and are arranged so as to face front sides of both the knees.

11. The health promoting apparatus according to claim 9, further comprising a chair including a seat portion for supporting buttocks of a jetting target person, and a slope portion for supporting a chest of a jetting target person in a stooped state.

12. The health promoting apparatus according to claim 1, wherein the jetting target to be accommodated in the water tank is an upper limb of a jetting target person, and the opening portions are arranged on a bottom surface of the water tank.

13. The health promoting apparatus according to claim 1, wherein the jetting target to be accommodated in the water tank is upper limbs of a plurality of jetting target persons, and the opening portions are arranged on a plurality of side surfaces of the water tank.

14. The health promoting apparatus according to claim 1, wherein the jetting target to be accommodated in the water tank is a face of a jetting target person, the opening portions are arranged on a bottom surface and a side surface of the water tank, enable proximate jetting of microbubbles via a flexible pipe, and are arranged so as to face the face of the jetting target person.

15. The health promoting apparatus according to claim 1, wherein the jetting target to be accommodated in the water tank is a hand of a jetting target person, and the opening portions are arranged on a bottom surface of the water tank, enable proximate jetting of microbubbles via a flexible tube and are arranged so as to face the hand of the jetting target person.

16. The health promoting apparatus according to claim 1, wherein the jetting target object is a pet as a pet animal, and the opening portions are arranged on a bottom surface or a side surface of the water tank.

17. The health promoting apparatus according to claim 6, further comprising a movable carriage.

18. The health promoting apparatus according to claim 6, wherein a volume of the water tank of each of the microbubble generating devices is about 1 liter to about 20 liters.

19. The health promoting apparatus according to claim 1, wherein the water tank and a pump for feeding pressurized fluid to the microbubble generating devices arranged in the water tank are provided on separate movable carriages.

20. The health promoting apparatus according to claim 6, further comprising a heater.

21. The health promoting apparatus according to claim 6, further comprising a timer for controlling an operation of the health promoting apparatus.

22. The health promoting apparatus according to claim 6, wherein the health promoting apparatus is capable of controlling a jetting pressure, a flow rate or a liquid temperature of liquid containing microbubbles.
